(19) United States
(12) Patent Application Publication
(10) Pub. No.: US 2012/0106379 A1
(43) Pub. Date: May 3, 2012

(54) NETWORK MONITORING APPARATUS FOR MANAGING COMMUNICATION QUALITY AND A METHOD THEREFOR

(75) Inventor: Yoshitaka HAMAGUCHI, Nara (JP)

(73) Assignee: OKI ELECTRIC INDUSTRY CO., LTD., Tokyo (JP)

(21) Appl. No.: 13/286,191

(22) Filed: Oct. 31, 2011

(30) Foreign Application Priority Data
Nov. 1, 2010 (JP) 2010-245257

(51) Int. Cl. H04L 12/26

(52) U.S. Cl. 370/252

(57) ABSTRACT

In a communication quality monitoring apparatus, a learning estimator uses collected network information and operational expressions for service quality to update the expressions based on a difference between an estimation of the quality and service quality information to learn the relationship between the loads and the quality. Based on the service quality information, a determiner determines whether or not the quality is lower than a predetermined value. When the quality is determined lower than the predetermined value, a control selector generates candidate information based on the network information and network configuration information, and determines, before control, whether or not the service quality estimation obtained from this candidate information and the operational expression exceeds the predetermined value. Apiece of candidate information determined as exceeding this value is selected. Based on control contents in the candidate information, a network controller controls the network devices.

### BACKGROUND OF THE INVENTION

1. Field of the Invention

The present invention relates to a network monitoring apparatus and a method therefor, and more particularly to a network monitoring apparatus suitable for use in monitoring a telecommunications network in order to manage the quality of real-time communications.

2. Description of the Background Art

In a conventional network management, an operator monitors network devices constituting a telecommunications network. When a failure, or malfunction, occurs in some of the network devices during the monitoring, the operator directly deals with the failure on the basis of his or her experiences and skills.

However, since such measures against failure largely depend on the experiences and skills of a specific operator, he or she cannot readily achieve a stable management on a network, which is problematic.

Therefore, in order to solve such a problem, U.S. Pat. No. 7,827,446 B2 to Kimura et al., discloses a failure recovery system and a server therefor. The server stores information on network devices to be monitored, classified by the types of network device, in connection with information on measures against failure that may occur in the network devices. Then, in response to a request for information on measures being received from a network device, the server provides the network device with a sequence of information on measures until the server fails to receive such a request for information on measures from that network device.

In recent years, network communications increasingly involve real-time communications such as multimedia communications, thus imposing a more extensive real-time capability on the communications. Such a real-time capability is different in characteristics from other kinds of network communications.

For example, when a server communicates with a terminal unit over a telecommunications network on a real-time basis to provide the user of the terminal unit with services, such as video or music contents, some of the network devices constituting the network may sometimes be involved in a slight failure, such as loss or short delay of a few packets. When such a failure occurs, it may be recognized by the user of the terminal unit as negligible momentary noise, which would hardly affect the quality of the service. Nevertheless, each time some of the network devices involve in a loss or delay of a packet, they are rendered to stop transmitting a packet to the terminal unit. When the packet in question is re-transmitted to the server, the real-time capability of communications is lost so as to significantly deteriorate the quality of the service.

Therefore, conventional real-time communications systems may often be designed not to stop transmitting packets to a terminal unit even when a slight failure occurs in a network device.

However, when a loss or delay of packets occurs in plural network devices on a network path extending from the server to the terminal unit, the loss or delay may be recognized slight by each network device but will cumulatively be increased each time packets pass through those failed network devices. Thus, when packets reach the destined terminal unit, the loss or delay has remarkably increased to the extent that the quality of service (QoS) is significantly deteriorated.

Conventional real-time communications thus suffer from a problem that the quality of service would not be estimated only by the degree of failure caused by a loss or delay of packets in individual network devices.

In order to solve this problem, it would be considered to apply the solution disclosed in Kimura et al., to real-time communications. In general, however, real-time communications may include a huge amount of network devices to be restored when failure occurs. Therefore, if individual network devices were dealt with against a failure, when occurring, by the solution of Kimura et al., the quality of service would not often be improved. Even if the quality of service were improved, it would take too much time until the quality is improved.

### SUMMARY OF THE INVENTION

It is therefore an object of the present invention to provide a network monitoring apparatus and a method therefor in which the quality of service can be improved even under the situation that in network communications, particularly in real-time communications, the quality of service would not be estimated by the degree of failure caused by a loss or delay of a packet in individual network devices.

In accordance with the present invention, a network monitoring apparatus comprises: a network information collector collecting network information on the load of each of a plurality of network devices constituting a telecommunications network; a service quality information collector collecting service quality information on a quality of a service provided over the network; a learning estimator using the collected network information and an operational expression for deriving the quality of the service to update the operational expression on the basis of a difference between estimation information on estimation of the quality of the service and the service quality information to learn a correspondence relationship between the load of each of the network devices and the quality of the service; a determiner using the collected service quality information to determine whether or not the quality of the service is lower than a predetermined control modification reference value; a control selector operative in response to the determiner determining that the quality of the service is lower than the predetermined control modification reference value to generate a piece of candidate information of control contents based on the network information and configuration information of the network, and determining, before control, whether or not service quality estimation information for search obtained on the basis of the piece of candidate information and the operational expression has a first value equal to or higher than the predetermined control modification reference value, the control selector selecting such one of the pieces of candidate information for the network devices that is determined to lead to the first value; and a network controller operative in response to the control contents included in the selected piece of candidate information to control the network devices.

Further in accordance with the present invention, a network monitoring apparatus comprises: a network information collector collecting network information on the load of each of a plurality of network devices constituting a telecommunications network; a service quality information collector collecting service quality information on a quality of service provided over the network; a learning circuit storing the collected network information in association with the collected service quality information, and learning a correspondence relationship between the loads of the network devices and the quality of the service; a determiner using the collected service quality information to determine whether or not the quality of the service is lower than a predetermined control modification reference value; a control selector operative in response to the determiner determining that the quality of the service is lower than the predetermined control modification reference value to search the learning circuit for the network information stored in the learning circuit to determine, before control, whether or not a value of the quality of the service read out on the basis of the network information is equal to or higher than the predetermined control modification reference value; and a network controller controlling the network devices on the basis of the selected network information, the control selector further selecting such one of pieces of network information obtained through the retrieval that is closest to a current load to output the selected piece of network information.

In accordance with an aspect of the invention, a method for monitoring a telecommunications network constituted by a plurality of network devices in a system including a terminal unit connected to the network and receiving a service provided over the network and a network monitoring apparatus for monitoring the network devices comprises the steps of: in the network monitoring apparatus, collecting network information on the load of each of the network devices; collecting service quality information on a quality of a service provided over the network; using the collected network information and the collected service quality information to learn a correspondence relationship between the load of each of the network devices and the quality of the service; determining whether or not the quality of the service is lower than a predetermined control modification reference value on the basis of the collected service quality information; estimating, when it is determined that the quality of the service is lower than the predetermined control modification reference value, the quality of the service on the basis of the learned correspondence relationship, and selecting information on a correspondence relationship in which the estimated quality of the service takes a value equal to or higher than the predetermined control modification reference value as control contents for the network devices; and controlling the network devices on the basis of the selected control contents.

In accordance with another aspect of the invention, a computer-readable record medium is provided which stores a monitor program causing a computer to implement the method set forth above.

In a network monitoring apparatus in accordance with the present invention, a network information collector collects network information on the load of each of a plurality of network devices constituting a telecommunications network. A service quality information collector collects service quality information on the quality of a service provided on the network. A learning estimator uses the collected network information and an operational expression for deriving the quality of the service to update the operational expression on the basis of a difference between estimation information on estimation of the quality of the service and the service quality information to learn the correspondence relationship between the load of each of the network devices and the quality of the service. A determiner determines whether or not the quality of the service is lower than a predetermined control modification reference value on the basis of the collected service quality information. A control selector generates candidate information of control contents based on the network information and configuration information of the network. When it is determined that the quality of the service is lower than the predetermined control modification reference value, the control selector determines, before control, whether or not service quality estimation information for search obtained on the basis of this candidate information and the operational expression has a value equal to or higher than the predetermined control modification reference value, and selects one piece of candidate information for the network devices determined to have this value. A network controller controls the network devices on the basis of the control contents included in the selected candidate information. That may allow the control contents for each of the network devices to be selected so as to render the quality of the service to be equal to or higher than the predetermined control modification reference value, regardless of the load of each network device. Therefore, the quality of service can be improved even when the degree of failure, or malfunction, in network devices does not directly relate to the quality of service.

In a network monitoring apparatus in accordance with the present invention, a network information collector collects network information on the load of each of a plurality of network devices constituting a telecommunications network. A service quality information collector collects service quality information on the quality of a service provided on the network. A learning circuit stores the collected network information in association with the collected service quality information, and learns the correspondence relationship between the loads of the network devices and the quality of the service. A determiner determines whether or not the quality of the service is lower than a predetermined control modification reference value on the basis of the collected service quality information. When it is determined that the quality of the service is lower than the predetermined control modification reference value determines through retrieval, a control selector searches the learning circuit for network information to determine, before control, whether or not the value of the quality of the service read out on the basis of the network information thus searched for is equal to or higher than the predetermined control modification reference value. The control selector selects such one of the pieces of network information obtained through the searching that corresponds to a value closest to the current load, and outputs the selected piece of network information. A network controller controls the network devices on the basis of the selected network information. That may allow not only the quality of service to be improved even when the degree of failure in network devices does not directly relate to the quality of the service, but also the components and elements for use in learning to be simplified in configuration.

Further, a method for monitoring a telecommunications network and a computer-readable record medium storing a monitor program therefor in accordance with the invention can improve the quality of service even when the degree of failure in network devices does not directly relate to the quality of service. More in general, the method for monitoring a network and the computer-readable record medium storing the monitor program therefor can improve communication control by determining, before control, the adequateness of the quality of real-time service provided by control contents.

### BRIEF DESCRIPTION OF THE DRAWINGS

The objects and features of the present invention will become more apparent from consideration of the following detailed description taken in conjunction with the accompanying drawings in which:

FIG. 1 is a block diagram showing a schematic configuration of a preferred embodiment of a service quality monitoring system to which applied is a network monitoring system in accordance with the present invention;

FIG. 2 is a block diagram showing a schematic configuration of the communication quality monitoring apparatus shown in FIG. 1;

FIG. 3 is a flowchart useful for understanding a general operational sequence of the communication quality monitoring apparatus shown in FIG. 2;

FIG. 4 is a flowchart useful for understanding an operational sequence for the service quality information collecting process shown in FIG. 3;

FIG. 5 is a flowchart useful for understanding an operational sequence for the network information collecting process shown in FIG. 3;

FIG. 6 is a flowchart useful for understanding an operational sequence for the quality estimating process shown in FIG. 3;

FIG. 7 is a flowchart useful for understanding an operational sequence for the candidate generating and information calculating process shown in FIG. 3;

FIG. 8 is a flowchart useful for understanding an operational sequence for the error calculating and learning update process shown in FIG. 3;

FIG. 9 is a flowchart useful for understanding an operational sequence for the determining process shown in FIG. 3;

FIGS. 10 and 11 are a flowchart useful for understanding an operational sequence for the determination selection process shown in FIG. 3;

FIG. 12 is a flowchart useful for understanding an operational sequence for the network controlling process shown in FIG. 3;

FIG. 13 is a schematic block diagram showing an exemplified network constituted by the service quality monitoring system shown in FIG. 1;

FIG. 14 shows a correspondence relationship between loads of routers and the quality of service of the terminal units in the network shown in FIG. 13;

FIG. 15 is a block diagram showing a schematic configuration of an alternative embodiment of a service quality monitoring apparatus in accordance with the present invention;

FIG. 16 is a flowchart useful for understanding a general operational sequence of the communication quality monitoring apparatus shown in FIG. 15;

FIG. 17 is a flowchart useful for understanding an operational sequence for the information generating process shown in FIG. 16; and

FIG. 18 is a flowchart useful for understanding an operational sequence for the calculation retrieving process shown in FIG. 16.

### DESCRIPTION OF THE PREFERRED EMBODIMENTS

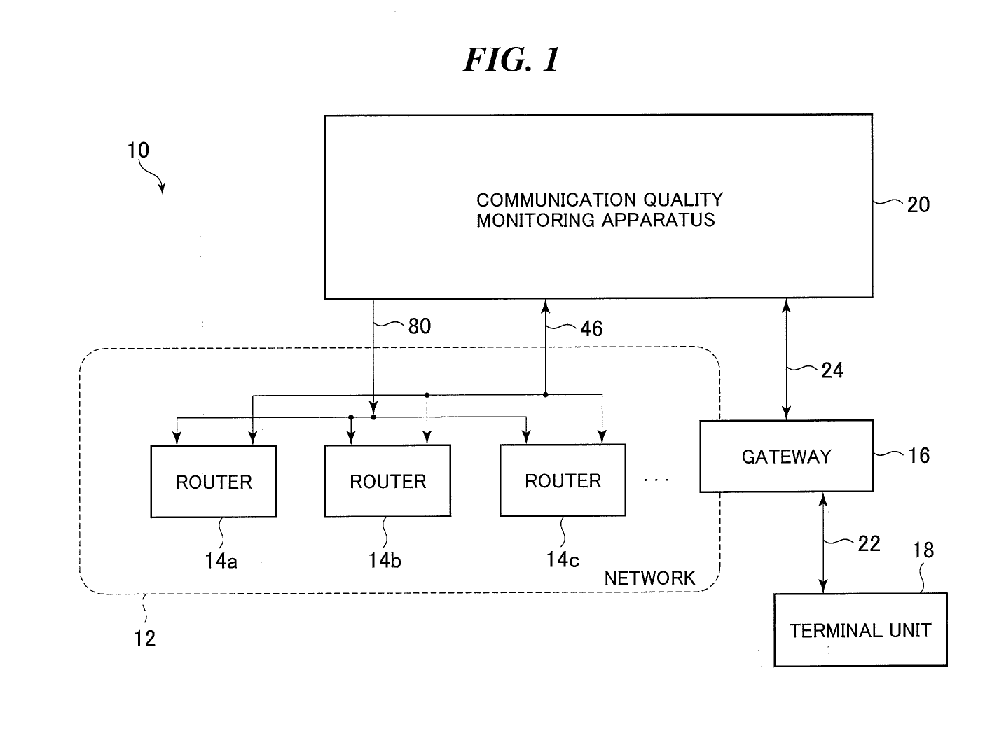

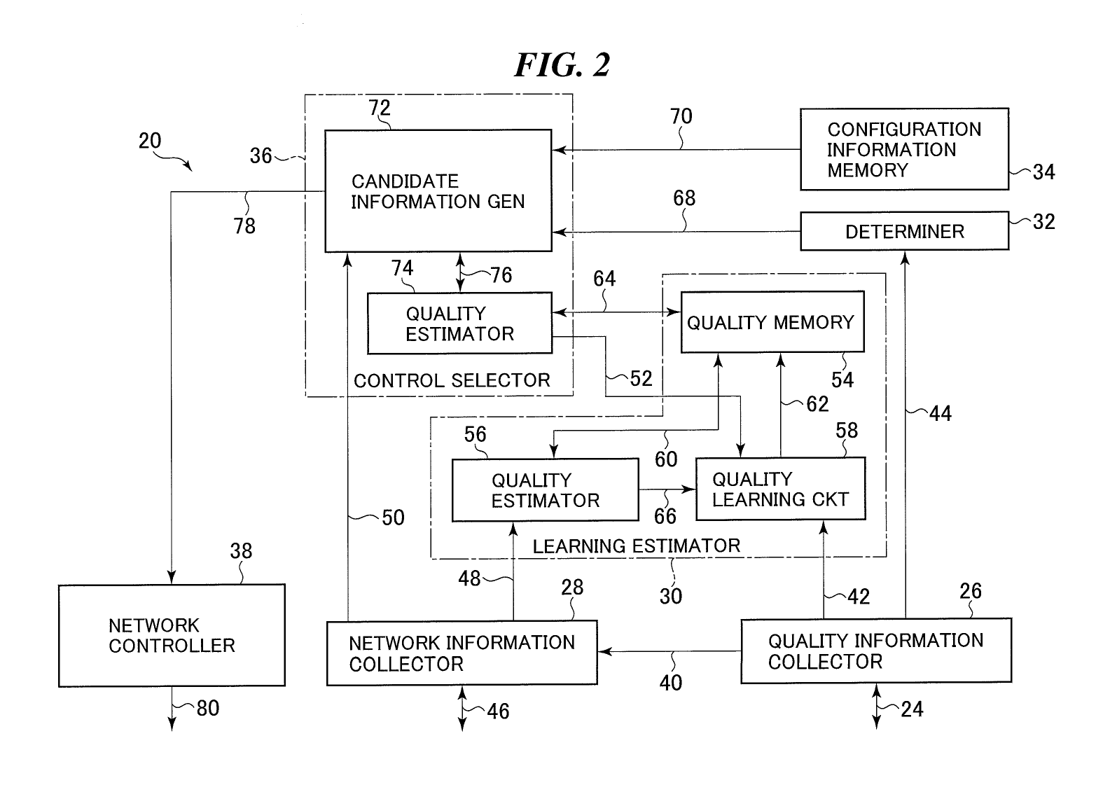

Well, reference will be made to the accompanying drawings to describe in detail a network monitoring apparatus in accordance with preferred embodiments of the present invention. With reference first to FIG. 2, an illustrative embodiment of a communication quality monitoring apparatus 20 will be described which is implemented as a sort of network monitoring apparatus. In the communication quality monitoring apparatus 20, a network information collector 28 collects network information 46 on the load of each of a plurality of routers constituting a telecommunication network 12, FIG. 1. A quality information collector 26 collects service quality information 24 on the quality of service (QoS) provided over the network. A learning estimator 30 uses the collected network information 48 and an operational expression 60 for use in deriving the quality of service to derive a difference between estimation information 66 on estimation of the quality of service and the service quality information 42 to update the operational expression to develop an updated operational expression 62. The learning estimator 30 learns the correspondence relationship between the load of each of the routers and the quality of service. A determiner 32 uses the collected service quality information 44 to determine whether or not the quality of service is lower than a predetermined control modification reference value. A control selector 36 is responsive to the quality of service being determined lower than the predetermined control modification reference value to generate candidate information of control contents based on the network information and configuration information 70 of the network, and determines, prior to control, whether or not service quality estimation information for search obtained on the basis of this candidate information and the operational expression has a value equal to or higher than the predetermined control modification reference value. The control selector 36 in turn selects one of the pieces of candidate information for the routers thus determined to be equal to or exceed the reference value to produce specific control information 78. A network controller 38 controls the routers on the basis of the control contents included in the selected candidate information. The communication quality monitoring apparatus 20 thus structured allows control contents to be selected for each of the routers such as to cause the quality of service to be equal to or higher than the predetermined control modification reference value, regardless of the load of each router. Therefore, even when the quality of service would not be estimated by the degree of failure, or malfunction, in each router, the quality of service can be improved.

Elements or portions not directly relevant to understanding the present invention will neither be described nor shown. In the description and accompanying drawings, signals, data and information are designated with reference numerals for connection lines on which they appear. Like components and elements are designated with the same reference numerals and repetitive descriptions thereon will be omitted.

Now, reference will be made to FIG. 1 to describe the configuration of a preferred embodiment of a service quality monitoring system 10 to which a network monitoring system in accordance with the present invention is applied. The service quality monitoring system 10 includes a plurality of routers 14a, 14b, 14c and so on, a gateway unit 16 and a terminal unit 18, in addition to the telecommunications network 12 and the communication quality monitoring apparatus 20.

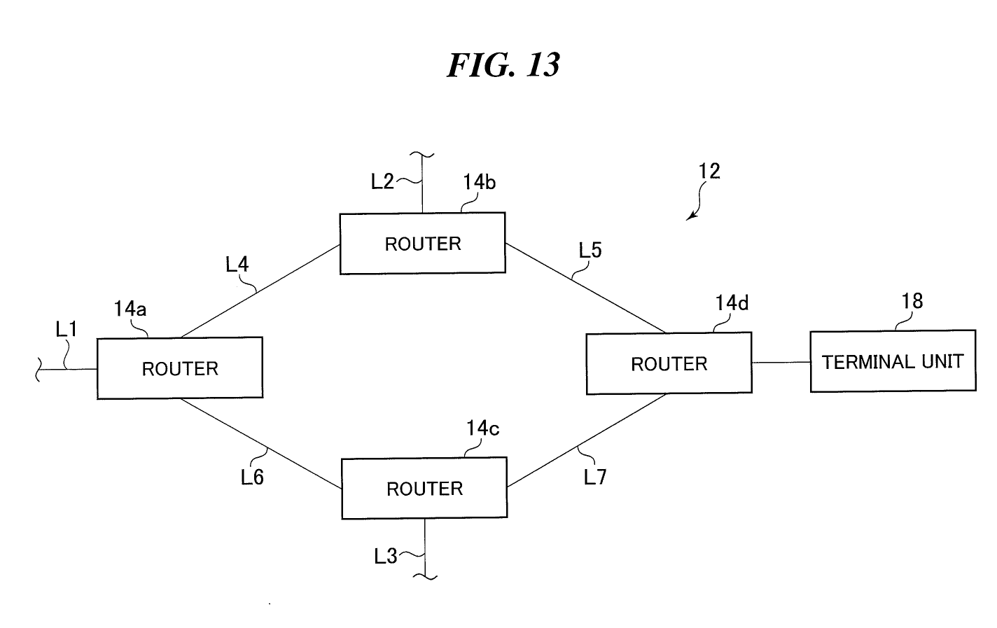

The telecommunications network 12 includes communication nodes through which transmission paths may be established to convey communication information. In the illustrative embodiment of the network 12, such communication nodes may be implemented by the routers 14a, 14b, 14c and so on which may be linked to each other, as exemplarily shown in FIG. 13. The network 12 transfers various kinds of information, or data, such as image information, video information and audio information over the links. The network 12 may be wired or wireless.

The routers 14a, 14b, 14c and so on are a kind of network devices interconnected to each other to monitor and manage the transmission paths or links. The monitor and management may cover information transfer, routing or path selection and communication state. The routers 14a, 14b, 14c and so on, thus interconnected by the links, transmit and receive various kinds of information to and from one another, as will be described later on.

FIG. 1 depicts only three routers 14a, 14b and 14c. However, the instant embodiment may include more routers. The routers 14a, 14b, 14c and so on may be of the same structure as each other, and adapted to produce network information on the load of itself to output the information to the communication quality monitoring apparatus 20.

Now, the load of the routers 14a, 14b, 14c and so on may be any sorts of load that may be quantified. Such loads may include, for example, a packet discarding ratio, a link usage ratio, a queue usage ratio, and a CPU (Central Processing Unit) usage ratio. Those ratios may be calculated by appropriate methods. For example, the packet discarding ratio may be calculated out by dividing the number of packets discarded at a unit period of time by the total number of packets received at the same unit period of time. The link usage ratio may be calculated out by dividing the number of links used at a certain time by the total number of links connected to the routers 14a, 14b, 14c and so on.

The queue usage ratio may be calculated out by dividing a queue length at current time by the maximum length, or capacity, of the queue a router of interest is designed to hold. The queue length at current time may be defined as the number of packets stored in a router of interest at a certain time. The maximum queue length of a router may be defined as the maximum number of packets which the router can store. The CPU usage ratio may be calculated out by dividing a period of time a CPU is used during a unit period of time by this unit period of time.

The gateway unit 16 has a general function to interface with a network having a different protocol. Specifically, the gateway unit 16 is interconnected to the network 12 as shown in FIG. 1, and adapted to output information 22, received from the network 12, to the terminal unit 18. The gateway unit 16 is also adapted to quantify information received from the network 12, i.e. information on the quality of service, to output the quantified quality as service quality information 24 to the communication quality monitoring apparatus 20. In the specification, information the gateway unit 16 receives from the network 12 may be referred to simply as “service”.

The quality of service may be of any kinds of quantity that can be quantified to represent a quality of service. The quality of service can be represented on the basis of, for example, a packet loss ratio, jitter, a packet delay, a mean opinion score (MOS) value, or a scalar quality rating value (R-value) defined by the International Telecommunication Union Telecommunication Standardization Sector (ITU-T) Recommendation G.107.

The MOS value is defined as an estimated MOS value calculated on the basis of an R-value according to ITU-T Recommendation G.107, Annex C. The R-value is calculated according to the E-Model of ITU-T Recommendation G.107.

It will briefly be described how to calculate those quantities as an indicator of the quality of service. When using the quality based on packet loss, for example, the gateway unit 16 may divide the number of packets the gateway unit 16 has actually received among packets configuring a certain service by the total number of packets configuring the service to thereby obtain a resultant value. Then, the gateway unit 16 subtracts the obtained value from unity, and will deal with the ultimate value as a value of quality based on packet loss. Therefore, for calculation of a packet loss ratio by the gateway unit 16, it is sufficient for each packet to have the total number of packets configuring a service of interest described.

When using the quality based on jitter, the gateway unit 16 may, for example, divide a difference between the maximum arrival interval and the minimum arrival interval during unit time by an average value of arrival intervals during this unit time to thereby obtain a resultant value. The arrival interval may be defined as a period of time from the arrival of a packet to the arrival of another packet following the former at the gateway unit 16. The gateway unit 16 may subtract the resultant value from unity, and will deal with the ultimate value as a value of quality based on jitter.

When using the quality based on packet delay, the gateway unit 16 may, for example, divide a period of time from the arrival of a packet to the arrival of another packet following the former at the gateway unit 16 by a predetermined period of reference time to thereby produce a resultant value. The predetermined period of reference time may be preset in the gateway unit 16, and will become the maximum value of possible delay time. Then, the gateway unit 16 subtracts the resultant value from unity, and will deal with the ultimate value as a value of quality based on packet delay.

The MOS value is an indicator of quality which is for use in audible services and actually sensed by the user of the terminal unit 18 when he or she listens to the audible service. This value is subjective, but can be calculated out by known algorithm such as the perceptual speech quality measure (PSQM). Thus, when using the quality based on MOS value, the gateway unit 16 may, for example, use the PQMS to calculate a MOS value of a service, and divide the obtained MOS value by the maximum value of MOS values. Then, the gateway unit 16 will deal with the resultant value as a value of quality based on MOS value.

The R-value is one of the indicators evaluating sound and voice as described above, and may be calculated out also by known algorithm. Thus, when using the quality based on R-value, the gateway unit 16 may, for example, use known algorithm to calculate an R-value of a service, and divide the obtained R-value by the maximum value of R-values. The gateway unit 16 will deal with the resultant value as a value of quality based on R-value.

The gateway unit 16 is so adapted as described above to calculate out the quality of service in any of the two manners immediately described above for services of audio information, and by means of quality values based on any of packet loss ratio, jitter and packet delay for services of the other sorts of information. The gateway unit 16 is also adapted to calculate, each time receiving a service, the quality of this service to output the service quality information 24 to the communication quality monitoring apparatus 20. The illustrative embodiment of the service quality monitoring system 10 shown in FIG. 1 may include plural gateway units corresponding to the gateway unit 16.

The terminal unit 18 has a user interface function to allow data to be input from and output to the user. The terminal unit 18 may be an intelligent or dedicated terminal unit having various processing functions such as editing text data and printing data. In order to perform various processes, the terminal unit 18 may be implemented by a processor system, such as a computer, including, for example, a CPU, a ROM (Read-Only Memory), a RAM (Random Access Memory), a hard disk drive, communication circuitry, a display and a keyboard, not shown, such that the CPU operates under the control of program sequences stored in the ROM, RAM and hard disk to perform, for example, various processes for providing the user with information 22 from the gateway unit 16. FIG. 1 depicts only one terminal unit 18, but may obviously include plural terminal units equivalent to the terminal unit 18. Control program sequences for functioning a computer as the terminal unit 18 may be stored in a recording medium, such as an optical disk, not shown, and installed from the medium to the computer to run.

The terminal unit 18 may be adapted to calculate the above-described qualities of service. In that case, the service quality information 24 may be provided to the communication quality monitoring apparatus 20 from the terminal unit 18.

The communication quality monitoring apparatus 20 has a function to monitor the quality of communication information flowing over the network 12 to manage the network 12 on the basis of the result obtained by the monitoring. Also, the communication quality monitoring apparatus 20 may basically be implemented by a processor system, such as a computer, including, for example, a CPU, a ROM, a RAM, a hard disk drive and communication circuitry, not shown. The communication quality monitoring apparatus 20 may include, as shown in FIG. 2, a quality information collector 26, a network information collector 28, a learning estimator 30, a determiner 32, a configuration information memory 34, a control selector 36, and a network controller 38, which are interconnected as illustrated. In a storage medium such as a hard disk, program sequences may be stored which implement the functions of the quality information collector 26, the network information collector 28, the learning estimator 30, the determiner 32, the configuration information memory 34, the control selector 36, and the network controller 38 described below. Control program sequences for functioning a computer as those functional components may be stored in a recording medium, such as an optical disk, not shown, and installed from the medium to the computer to run.

In FIG. 2, the illustrative embodiment of the communication quality monitoring apparatus 20 is depicted, and also will be described, as configured by those separate functional blocks. It is however to be noted that such a depiction and a description do not restrict the monitoring apparatus 20 to an implementation only in the form of hardware but the apparatus 20 may partially or entirely be implemented by software. That may also be the case with illustrative embodiments of the terminal unit 18, and other components of the communication quality monitoring system 10. In this connection, the word “circuit” or “circuitry” may be understood not only as hardware, such as an electronics circuit, but also as a function that may be implemented by software installed and executed on a computer.

The quality information collector 26 has a function to collect the service quality information 24 supplied thereto to deliver the collected information to the respective sections. It is described above that the communication quality monitoring apparatus 20 is connected to the gateway unit 16. More in detail, the quality information collector 26 is connected to the gateway unit 16 so as to transmit and receive information. The quality information collector 26 receives the service quality information 24 from the gateway unit 16. The quality information collector 26 outputs the received service quality information 24 as service quality information 40, 42 and 44 to the network information collector 28, the learning estimator 30 and the determiner 32, respectively, at a predetermined timing.

The network information collector 28 is connected to the routers 14a, 14b, 14c and so on in the network 12 to function as transmitting and receiving information to acquire information 46 on the network 12 at a predetermined timing. The predetermined timing is defined as a timing at which the service quality information 40 is supplied from the quality information collector 26. At this timing, the network information collector 28 transmits request information 46 for requesting transmission of network information to each of the routers 14a, 14b, 14c and so on in the network 12. The routers 14a, 14b, 14c and so on calculate, when receiving the request information 46, the respective loads thereof in any of the above manners, and transmit network information 46 on the calculated loads to the network information collector 28. The network information collector 28 acquires upon reception the network information 46 from those routers 14a, 14b, 14c and so on to output the acquired information as network information 48 and 50 to the learning estimator 30 and the control selector 36, respectively.

The learning estimator 30 has a function to use the service quality information 42 supplied from the quality information collector 26, the network information 48 supplied from the network information collector 28 and network candidate information described below to estimate the correspondence relationship between the load and the quality of service on each of the routers 14a, 14b, 14c and so onto store a estimation result, and to repeat that process by trial and error, for example, to thereby learn the correspondence relationship. The learning estimator 30 may be adapted to use the quality of service 52 obtained from a learned operational expression. In this case, the learning estimator 30 uses a difference between the quality of service 52 and the collected service quality information 42 to update the operational expression. In order to implement this function, the learning estimator 30 includes a quality memory 54, a quality estimator 56 and a quality learning circuit 58, which are interconnected as depicted.

The quality memory 54 is adapted to store operational expressions. In the instant embodiment, the quality memory 54 is particularly adapted for storing operational expressions for deriving values on the layers of a neural network or a neuro-network. The quality memory 54 has the initial values of operational expressions stored for use in its initial state, and appropriately updates the operational expressions from the initial values through learning described below. To the quality memory 54, supplied are the estimated quality of service from the quality estimator 56 described below and a propagation coefficient 62 from the quality learning circuit 58. The quality memory 54 supplies stored data 64 to the control selector 36 and outputs the data as data 60 to also the quality estimator 56.

The operational expressions will briefly be described. The neural network has an input layer, a plurality of intermediate layers and an output layer. The input layer, the intermediate layers and the output layer each use one or more parameters with the parameters associated with each other between the different layers.

Specifically in this illustrative embodiment, the parameters of the input layer correspond to the loads of the routers 14a, 14b, 14c and so on, and the parameters of the output layer corresponds to the quality of service. Therefore, the parameters of the input layer correspond in number to the routers, and the output layer has a single parameter. Obviously, when the number of terminal units 18 to be monitored in terms of the quality of service is increased, the number of the parameters of the output layer is also increased accordingly. In the instant embodiment, the number of parameters of each intermediate layer is set so as to be equal to the number of parameters of the input layer.

The operational expression of the quality memory 54 is prepared for deriving the values of the intermediate and output layers. For example, the j-th parameter gⱼ^{k} of the k-th intermediate layer is represented by an expression (1):

$${g}_{j}^{k} = f ( {\sum }_{i} {g}_{i}^{k - 1} {ω}_{j , i}^{k , k - 1} ) \qquad ( 1 )$$

where ω_{j,i}^{k,k-1} is a propagation coefficient, a variable k is a positive integer representing the ordinal number of an intermediate layer and taking unity to a natural number m, inclusive, a variable j is a positive integer representing the ordinal number of a router and taking unity to a natural number n, and a variable i is a positive integer representing the number of routers and taking zero to a natural number n. Thus, gᵢ⁰ represents the i-th parameter of the input layer, namely, the load of corresponding one of the routers. Particularly, gᵢ^{k-1} is equal to one when the variable i is equal to zero.

The function f in the expression (1) is a sigmoid function represented by an expression (2):

$$f ( x ) = \frac{1}{1 + exp ( - x )} \qquad ( 2 )$$

The output layer has its parameter u represented by an expression (3):

$$u = f ( {\sum }_{i} {g}_{i}^{m} {h}_{i} ) \qquad ( 3 )$$

where hᵢ is a propagation coefficient.

Returning now to FIG. 2, the quality estimator 56 functions as using supplied plural pieces of network information 48 and the stored operational expressions to estimate the quality of service. Specifically, the quality estimator 56 substitutes the values of the loads of the routers 14a, 14b, 14c and so on into the respective parameters of the input layer of the neural network to calculate the values of the intermediate layers in the order from the intermediate layer closest to the input layer toward the farthest layer. The quality estimator 56 thus estimates the quality of service. The quality estimator 56 outputs the calculated information on quality as service quality estimation information 66 to the quality learning circuit 58. The quality estimator 56 also outputs plural pieces of network information 66 to the quality learning circuit 58.

The quality learning circuit 58 has a function of using the service quality information 42 and the service quality estimation information 66 to derive a difference therebetween to update the operational expressions stored in the quality memory 54 through back propagation. The quality learning circuit 58 uses this function to learn the correspondence relationship between the loads of the routers 14a, 14b, 14c and so on and the quality of service.

It will be described how the quality learning circuit 58 proceeds to calculation. The quality learning circuit 58 uses expressions (4) and (5) to update the propagation coefficient hᵢ:

h′ᵢ=hᵢ=ηgᵢ^{m}δ (4)

δ=(b−u)u(1−u) (5)

where h′ⱼᵢ is the coefficient hᵢ after updated, η is a predetermined learning coefficient, b is a value represented by the service quality information, i.e. an actually measured value of the service quality, and u is a value represented by the service quality estimation information, i.e. an estimated value of the service quality.

The quality learning circuit 58 uses expressions (6), (7) and (8) to update a propagation coefficient for defining the parameter of an intermediate layer in the order from the intermediate layer closest to the output layer toward the farthest layer:

$$\begin{matrix}{ω}_{j , i}^{′k , k - 1} = {ω}_{j , k}^{k , k - 1} + η {g}_{i}^{k - 1} {δ}_{j}^{k} & ( 6 ) \\ {δ}_{j}^{k} = {g}_{j}^{k} ( 1 - {g}^{k} ) {\sum }_{i} {δ}_{i}^{k + 1} {ω}_{i , j}^{K + 1 , k} & ( 7 ) \\ {δ}_{i}^{m + 1} = δ & ( 8 )\end{matrix}$$

where ω′_{j,i}^{k,k-1} is a propagation coefficient ω_{j,i}^{k,k-1} after updated.

The quality learning circuit 58 uses, after having updated all the propagation coefficients, propagation coefficients thus updated to estimate the quality of service. More specifically, the quality learning circuit 58 substitutes the values of the loads of the routers 14a, 14b, 14c and so on into the respective parameters of the input layer of the neural network to calculate the value of each intermediate layer in the order to thereby calculate out the quality of service. The quality learning circuit 58 determines whether or not the calculated service quality, or the estimated quality, matches the quality represented by the service quality information, and repeats update of a propagation coefficient until both the quality match each other. The quality learning circuit 58 outputs the obtained propagation coefficient 62 to the quality memory 54.

In that way, as a way of learning the correspondence relationship between loads of the routers 14a, 14b, 14c and so on and the quality of service, the learning estimator 30 using a neural network. Obviously, other kinds of learning systems, such as Bayes, may be applied. In general, the correspondence relationship between loads of the routers 14a, 14b, 14c and so on and the quality of service may often be nonlinear. Thence, for the learning estimator 30, preferable are methods suitable for learning a nonlinear correspondence relationship. The neural network is an example of method for learning a nonlinear correspondence relationship.

Returning again to FIG. 2, the determiner 32 has a function to use the supplied service quality information 44 to determine whether or not the quality of service is lower than a predetermined control modification reference value. When it is determined that the quality of service is lower than the predetermined control modification reference value, the determiner 32 provides the control selector 36 with anomaly information 68 representing that an anomaly actually occurs in the quality of service in the network 12. In the instant illustrative embodiment, the predetermined control modification reference value is set to an arbitrary value, for example, 0.7 or 70%.

The configuration information memory 34 has an information storing function, and is specifically adapted to store network configuration information representing how the network 12 to be monitored is configured, for example, the number, the type and the mutual connection status of the routers 14a, 14b, 14c and so on, and how the network 12 is connected to the exterior. When the configuration of the network 12 is changed, for example, as when a new router is added, the operator of the communication quality monitoring apparatus 20 updates the network configuration information. The configuration information memory 34 outputs the stored, updated network configuration information 70 to the control selector 36.

The control selector 36 has a function to use a determination result 68 of the determiner 32 and the network configuration information 70 for searching. More specifically, in the searching, the determination result 68 and the network configuration information 70 are used to select control contents in which pieces of service quality candidate estimation information calculated on the basis of the correspondence relationship between the loads of the routers and the quality of service obtained by learning are equal to or higher than a predetermined control modification reference value. In order to perform the searching process, the control selector 36 includes a candidate information generator 72 and a quality estimator 74 as shown.

The candidate information generator 72 has a function of using the pieces of network information 50 and the network configuration information 70 in response to the determination result 68 to generate pieces of control candidate information 76 representing control contents for the routers 14a, 14b, 14c and so on, and determining, prior to control, whether or not service quality estimation information 76 for searching obtained on the basis of the thus generated control candidate information and the operational expression has a value equal to or higher than the predetermined control modification reference value. The candidate information generator 72 in turn selects one of the pieces of control candidate information determined to be true, i.e. confirmed to have the aforementioned value to output the selected information. The control candidate information generated by the candidate information generator 72 is information representing how to control routing for the routers 14a, 14b, 14c and so on, i.e. over which path a service entering the network 12 leaves the network 12.

The candidate information generator 72 first uses the loads represented by the network information 50 to estimate current routing control as paths for respective services, and generates the control candidate information such that the homology with the estimated routing control is equal to or higher than a predetermined value. The predetermined value is set to 70% in the present embodiment. Specifically, when ten paths are estimated for a service, the candidate information generator 72 generates plural pieces of control candidate information 76 with only three of the ten paths modified. Additionally, those pieces of control candidate information are different from one another in at least one of the paths for the service. The candidate information generator 72 calculates, for each of the pieces of control candidate information, the respective loads of the routers 14a, 14b, 14c and so on when expected to be controlled in accordance with the control contents represented by the pieces of control candidate information. The candidate information generator 72 supplies the quality estimator 74 with network candidate information 76 on the calculated loads.

The quality estimator 74 functions as using the supplied network candidate information 76 and the operational expressions 64 stored in the quality memory 54 to calculate the quality of service to output the calculated quality of service to the candidate information generator 72 as the service quality estimation information 76. The quality estimator 74 is prepared for searching. The quality estimator 74 substitutes the values of the loads of the routers 14a, 14b, 14c and so on into the respective parameters of the input layer of the neural network to calculate the value of each intermediate layer in the order. Thus, the quality estimator 74 calculates out the quality of service as contents of searching. The quality estimator 74 outputs the calculated information on quality to the candidate information generator 72 as the service quality estimation information 76.

The candidate information generator 72 in turn determines or confirms whether or not the service quality estimation information 76, i.e. the quality of service, calculated by the searching included in the plural pieces of control candidate information is equal to or higher than the predetermined control modification reference value described above. Whenever the candidate information generator 72 determines that the above condition is satisfied, it selects one of the pieces of control candidate information satisfying the condition to output the selected information to the network controller 38. The candidate information generator 72 has the selected candidate information set as specific candidate information 78. When the candidate information generator 72 determines that the above condition is false, it determined that no specific candidate information exists, and repeats generating candidate information until it is confirmed that specific candidate information exists, thus continuing the searching process.

The candidate information generator 72 may preferably be adapted to use, while repeating the searching process, the pieces of control candidate information generated in the last searching as genetic codes to cross those genetic codes over one another to generate new control candidate information. The candidate information generator 72 is responsive to the generated control candidate information to repeat the searching process. The candidate information generator 72 may preferably use genetic algorithm to repeat the searching process.

Crossover of the pieces of control candidate information may be implemented by, for example, replacing part of the path for a service represented by a piece of control candidate information with a path represented by another piece of control candidate information. The candidate information generator 72 may cull some of the control candidate information prior to crossing-over. More specifically, the candidate information generator 72 may cull one or some of the pieces of control candidate information exhibiting the service quality lower than a predetermined cull reference value, and cross the rest of the pieces of control candidate information over one another. The predetermined cull reference value in the illustrative embodiment may be lower than the predetermined control modification reference value, and is set to, for example, 0.5. Additionally, the candidate information generator 72 may preferably be adapted to select such one of the pieces of specific candidate information that represents the highest quality of service.

The network controller 38, FIG. 2, is operative in response to the supplied specific candidate information 78 to control the routers 14a, 14b, 14c and so on. The network controller 38 generates a control signal 80 of control contents based on the supplied specific candidate information 78 to output the signal to each of the routers 14a, 14b, 14c and so on, thereby controlling the routers.

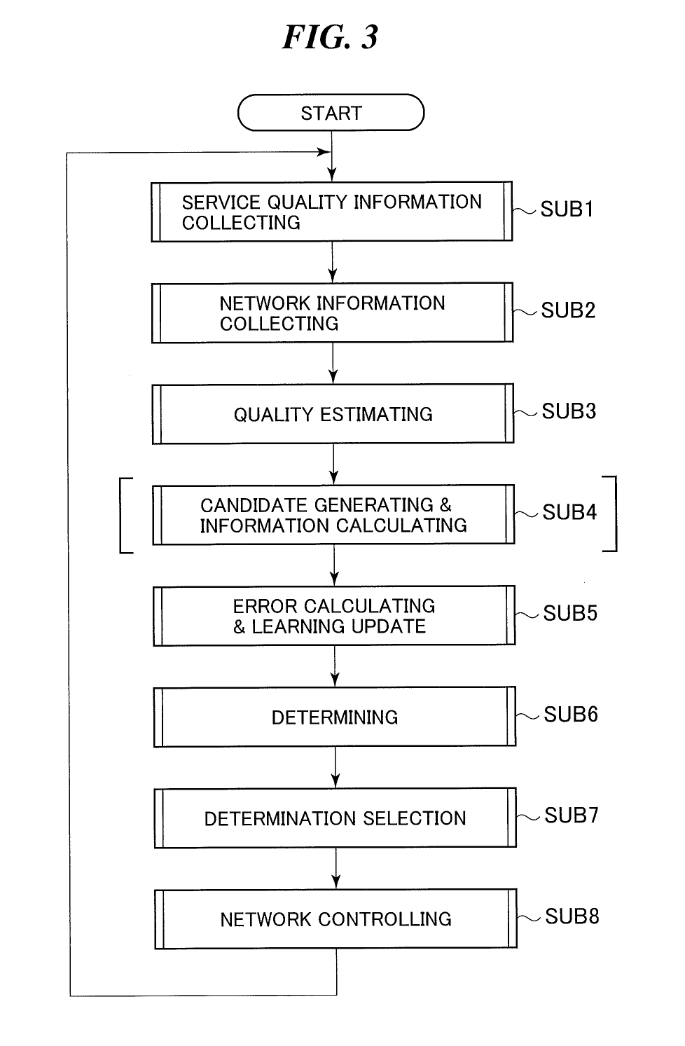

Next, the operation of the communication quality monitoring apparatus 20 in the service quality monitoring system 10 will be described with reference to the flowcharts shown in FIGS. 3 to 9. The communication quality monitoring apparatus 20 generally operates according to the processing steps shown in FIG. 3. At first, in a service quality information collecting process, or subroutine, SUB1, the quality information collector 26 collects the service quality information 24. Next, the network information collector 28 collects the network information 46 in a network information collecting subroutine SUB2.

Subsequently, the quality estimator 56 in the learning estimator 30 estimates the service quality in a quality estimating subroutine SUB3. The quality estimator 56 outputs the calculated service quality estimation information 66 to the quality learning circuit 58. The candidate information generator 72 in the control selector 36 generates the control candidate information in its candidate generating process, and the quality estimator 74 calculates the loads of the routers 14a, 14b, 14c and so on and the service quality estimation information corresponding to service quality in an information calculating subroutine SUB4. The subroutine SUB4 includes the candidate generating process and the information calculating process. The quality estimator 74 outputs the calculated service quality estimation information 76 to the candidate information generator 72.

Thereafter, the quality learning circuit 58 in the learning estimator 30 finds a difference between the service quality information 42 and the service quality estimation information 66 as an error, and finds, through learning, an operational expression on the basis of the obtained error to update the operational expression in an error calculating and learning update subroutine SUB5. The update is implemented by supplying the operational expression 62 to the quality memory 54 to store the operational expression therein. The determiner 32 determines the quality of service on the basis of the supplied service quality information 44, in a determining subroutine SUB6.

Next, in a determination selection subroutine SUB7, the candidate information generator 72 in the control selector 36 determines whether or not the calculated service quality estimation information 76 can be specific candidate information, and selects the specific candidate information as determined to be true. The candidate information generator 72 outputs the selected specific candidate information 78 to the network controller 38. The network controller 38 uses in its network controlling process the selected specific candidate information 78 as control contents to generate the control signal 80, and outputs the signal to each of the routers 14a, 14b, 14c and so on. After that control, the control returns to the service quality information collecting subroutine SUB1, and will repeat the sequential monitoring control loop.

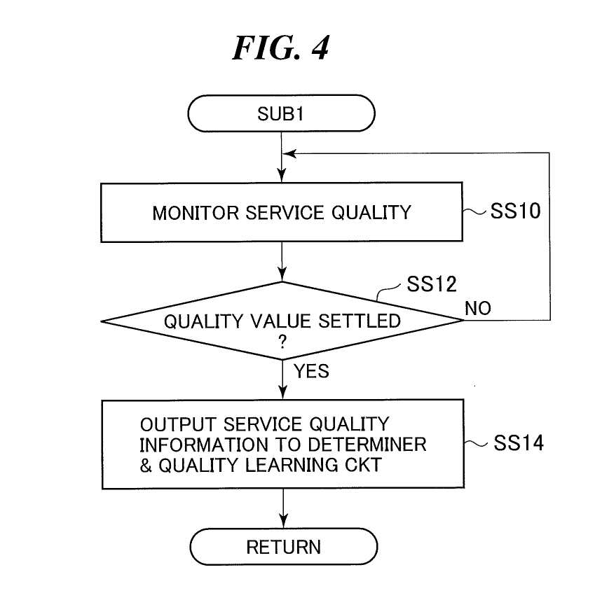

Now, procedures in those subroutines will briefly be described. The quality information collector 26 operates, as shown in FIG. 4, to follow the steps SUB1 of collecting the service quality information. In the service quality information collecting subroutine, the service quality information 24 supplied from the gateway unit 16 is received to monitor the service quality on the basis of the received service quality information 24 (substep SS10). The quality information collector 26 determines whether or not the quality of service has settled, on the basis of the received service quality information 24.

In the illustrative embodiment, the predetermined period of time is set to, for example, five minutes. The quality information collector 26 determines whether or not a difference between the maximum and minimum values of service quality monitored for the predetermined period of time is equal to or lower than a predetermined value to thereby determine the degree of settling (substep SS12). In this illustrative embodiment, the predetermined value is set to, for example, 0.1. When this difference is equal to or lower than the predetermined value (YES), the quality information collector 26 determines that the quality of service has settled, and progresses to an output substep SS14. Otherwise, namely, when this difference exceeds the predetermined value (NO), the step returns to the substep SS10 of monitoring the service quality.

The quality information collector 26 outputs the acquired service quality information 42 and 44 to the quality learning circuit 58 and the determiner 32, respectively (substep SS14). In turn, the communication quality monitoring apparatus 20 will be triggered by a determination that the quality of service has settled to start the processes for learning or the like as described above. After the output substep SS14, the control finishes the subroutine SUB1 to advance to the general control flow.

Meanwhile, the learning or the like may be started at another timing, for example, a timing the operator may arbitrarily set. In the instant illustrative embodiment, a stable, i.e. settled, value of service quality is used to perform the learning or the like. That may cause the accuracy of the learning to be improved in comparison to using a fluctuating, unstable value of the service quality.

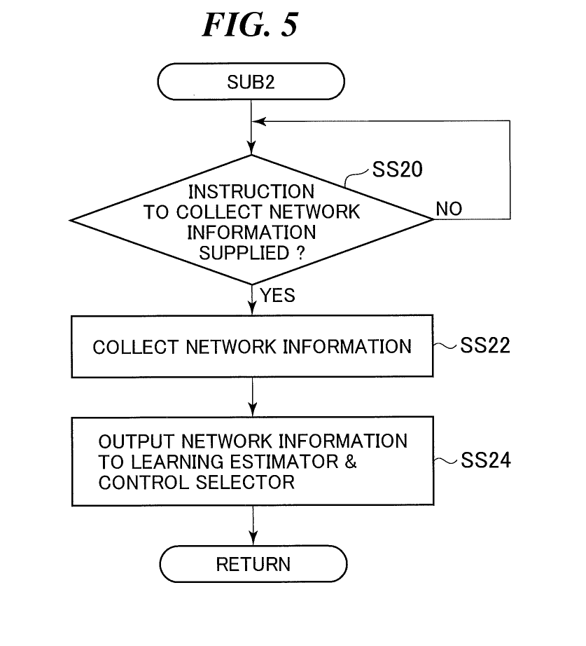

Next, the network information collecting process SUB2 by the network information collector 28 will be described with reference to FIG. 5. The network information collector 28 operates, as shown in FIG. 5, to follow the steps of collecting the network information. The network information collector 28 determines whether to have an instruction (substep SS20). When the network information collector 28 receives the service quality information 40 as instruction information from the quality information collector 26, it determines to have an instruction received (YES) to progress to a network information collecting substep SS22. Otherwise, that is, when the network information collector 28 has not received the service quality information 40 from the quality information collector 26, it determines to have no instruction (NO) to keep waiting until receiving an instruction.

The network information collector 28 collects network information in response to the service quality information 40 being supplied (substep SS22). This procedure of collecting will be described in detail. The network information collector transmits the request information 46 for requesting transmission of network information from the network information collector 28 to each of the routers 14a, 14b, 14c and so on. The routers 14a, 14b, 14c and so on calculate out the respective loads thereof in any of the manners described earlier, and transmit the loads as the network information 46 to the network information collector 28.

In the substep SS24, the network information collector 28 provides the quality estimator 56 of the learning estimator 30 and the candidate information generator 72 of the control selector 36 with the network information 46 collected, or received, from the routers 14a, 14b, 14c and so on as the network information 48 and 50, respectively. After the output substep SS24, the control returns to finish the subroutine SUB2.

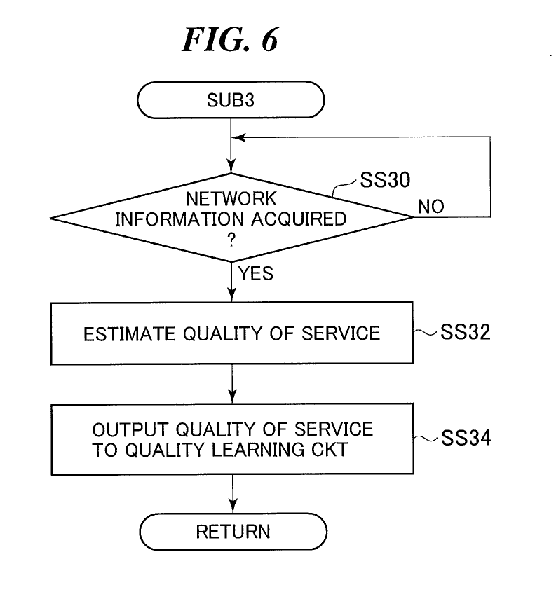

Next, the steps SUB3 of estimating the service quality by the quality estimator 56 will be described with reference to FIG. 6. The quality estimator 56 determines whether or to acquire the network information 48 (substep SS30). When the network information 48 is determined to be acquired (YES), the control advances to an estimating substep SS32. Otherwise, that is, when the network information 48 is determined not to be acquired (NO), the step keeps waiting (substep SS30).

In the estimating substep SS32 of the quality estimator 56, the above manner, i.e. the expressions (1), (2) and (3) are used to thereby calculate and estimate the quality of service. Next, the quality estimator 56 outputs information on the estimated service quality as the service quality estimation information 66 to the quality learning circuit 58 (substep SS34). Then, the quality estimator 56 also outputs the pieces of network information 66 to the quality learning circuit 58. After the output substep SS34, the control returns to finish the subroutine SUB3.

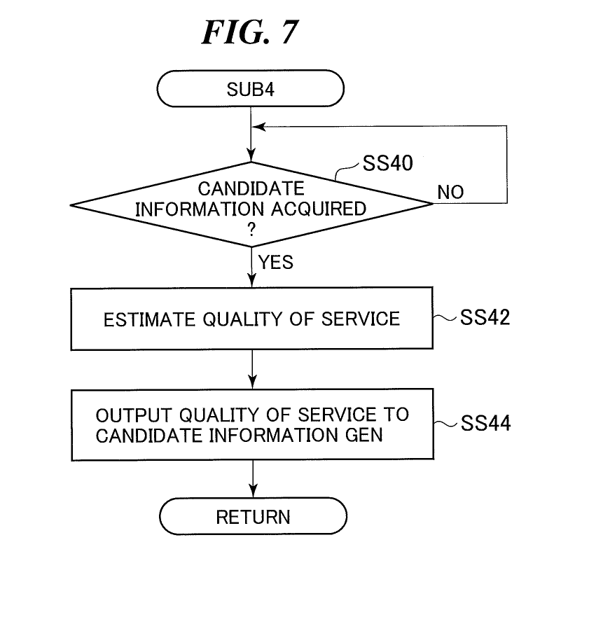

Next, the procedure SUB4 of estimating the service quality by the quality estimator 74 will be described with reference to FIG. 7. The quality estimator 74 functions for search whereas the quality estimator 56 functioning for learning. Although not explicitly illustrated in the subroutine SUB4, it is preferable for the candidate information generator 72 to generate, as illustrated in the subroutine SUB7, candidate information under the condition that anomaly information exists and the network information 50 is supplied. The quality estimator 74 determines whether to acquire the network candidate information 76 generated by the candidate information generator 72 (substep SS40). When the quality estimator 74 determines to acquire the network candidate information 76 (YES), it progresses to a quality estimating substep SS42 for the network. Otherwise, namely, when the quality estimator 74 determines not to acquire the network candidate information 76 (NO), it keeps waiting until it receives the network candidate information 76.

Subsequently in substep SS42, the quality estimator 74 calculates the quality of service on the basis of the above manner, i.e. the supplied network candidate information 76 and the operational expression 64 stored in the quality memory 54. The estimation of the quality of service for search is performed by substituting the values of the loads of the routers 14a, 14b, 14c and so on into the respective parameters of the input layer of the neural network to calculate out the value of each intermediate layer in the order. The quality estimator 74 in turn outputs information on the calculated quality of service as the service quality estimation information 76 to the candidate information generator 72 (substep SS44). After the output substep, the control returns to finish the subroutine SUB4.

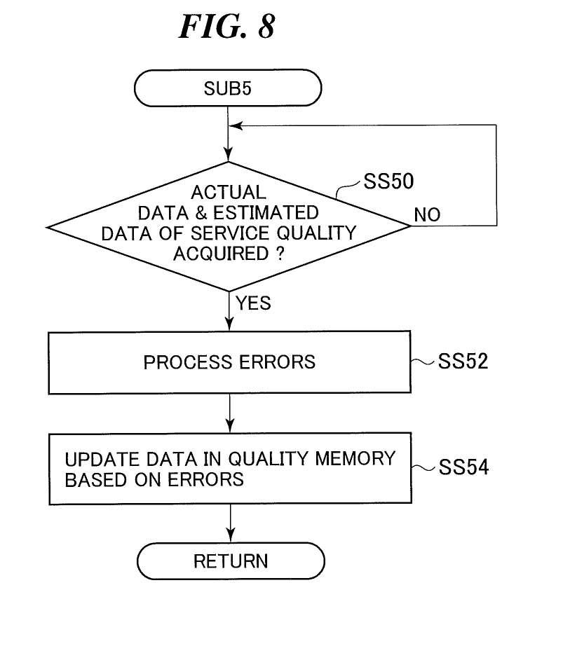

Next, the error calculating and learning update steps SUB5 in the quality learning circuit 58 will be described with reference to FIG. 8. The quality learning circuit 58 determines whether to acquire the service quality information 42 as actual data of the service quality and the service quality estimation information 66 as estimated data of the service quality (substep SS50). When the quality learning circuit 58 determines to acquire both the information 42 and 66 (YES), it advances to the error calculating substep SS52. Otherwise, namely, when determining not to acquire both the information 42 and 66 (NO), the quality learning circuit 58 keeps waiting until receiving both the information 42 and 66.

In response to both the information 42 and 66 being acquired, the quality learning circuit 58 processes an error processing substep SS52. The error in the context is defined as a difference between the service quality information 42 and the service quality estimation information 66. Next, on the basis of the errors, the quality learning circuit 58 updates the operational expressions stored in the quality memory 54 by back propagation (substep SS54). The back propagation is a kind of supervised learning method, which is one of the solutions of machine learning for use in training in a neural network. A specific manner for learning has been described above. After the learning substep SS54, the control returns to finish the subroutine SUB5.

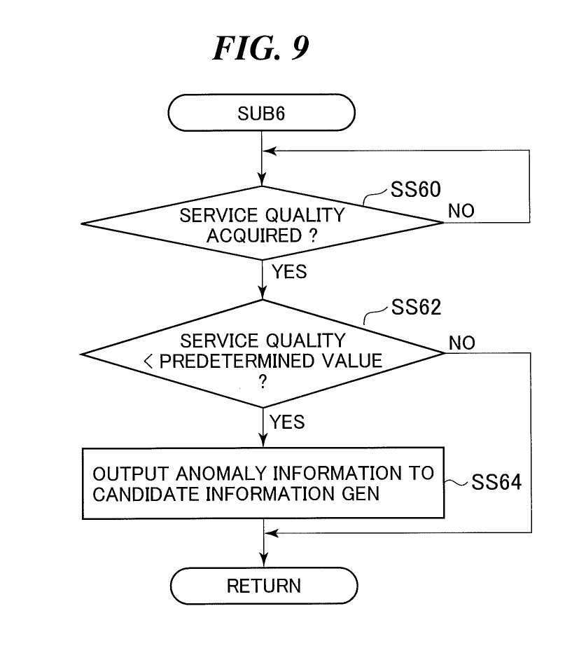

Next, the determining process SUB6 by the determiner 32 will be described with reference to FIG. 9. The determiner 32 determines whether to acquire the service quality information 44 (substep SS60). When the determiner 32 determines to acquire the service quality information 44 (YES), it progresses to a threshold value determining substep SS62. Otherwise, that is, when the determiner 32 determines not to acquire the service quality information 44 (NO), it keeps waiting until receiving the service quality information 44.

Next, in the threshold value determining substep SS62, it is determined on the basis of the supplied service quality information 44 whether or not the quality of service is lower than the predetermined control modification reference value. When determining that the quality of service is lower than the predetermined control modification reference value (YES), the determiner 32 progresses to an anomaly detecting substep SS64. Otherwise, namely, when the determiner 32 determines that the quality of service is equal to or higher than the predetermined control modification reference value (NO), it determines no anomaly to return the control.

In the anomaly detecting process, when the quality of service is lower than the reference value, an anomaly is determined to occur in the monitored network 12. On the basis of this determination, the determiner 32 outputs anomaly information 68 representing the occurrence of an anomaly to the candidate information generator 72 of the control selector (substep SS64). After the output substep, the control returns to finish the subroutine SUB6.

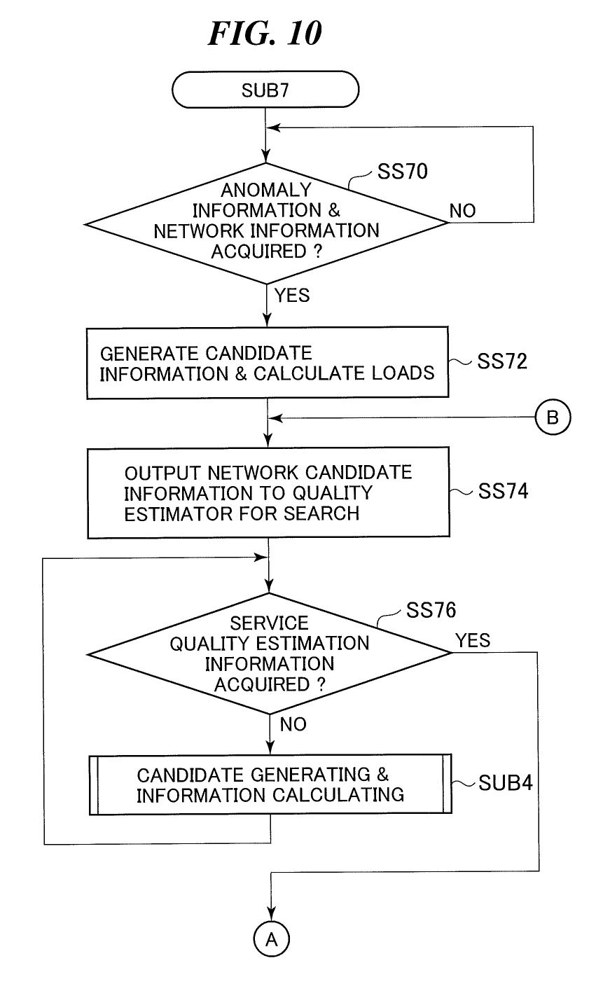

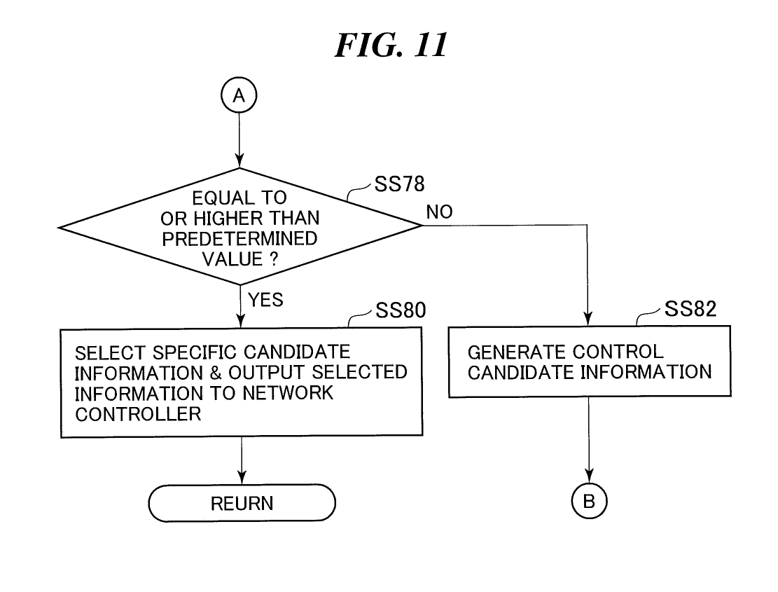

Next, the determination selection subroutine SUB7 by the candidate information generator 72 will be described with reference to FIGS. 10 and 11. The communication quality monitoring apparatus 20 in the instant embodiment has a function to constantly monitor the network 12 and control itself so as to cause the quality of service to satisfy a predetermined level even in an abnormal state. In order to implement this function, the candidate information generator 72 performs the determination selection subroutine SUB7.

The candidate information generator 72 first determines whether to acquire the anomaly information 68 and the network information 50 (substep SS70). Whenever the candidate information generator 72 determines to acquire the anomaly information 68 and the network information 50 (YES), it reports that the network 12 is in its abnormal state, and therefore, progresses to a candidate information generating substep SS72. Otherwise, namely, when the candidate information generator 72 determines not to acquire the anomaly information 68 and the network information 50 (NO), it keeps waiting until receiving the anomaly information 68 and the network information 50. Thus, the candidate information generator 72 can be caused operable only in an abnormal state, which can reduce power consumption.

The candidate information generator 72 will in turn perform the candidate information generating substep SS72. In the candidate information generating substep, the candidate information generator 72 generates the pieces of control candidate information and calculates, for each piece of control candidate information, the loads of the routers 14a, 14b, 14c and so on which would be caused when controlled according to the control contents included in that piece of control candidate information. Then, the candidate information generator 72 outputs the calculated loads as the network candidate information 76 on the loads to the quality estimator 74 for search (substep SS74).

Subsequently, the candidate information generator 72 determines whether to acquire the service quality estimation information 76 (substep SS76). When the candidate information generator 72 determines to acquire the service quality estimation information 76 (YES), it advances its control to a threshold value determining substep SS78, FIG. 11, via a connector A. Otherwise, that is, when the candidate information generator 72 determines not to acquire the service quality estimation information 76 (NO), it transfers its control to the subroutine SUB4, FIG. 7, for calculating the service quality estimation information 76, i.e. the candidate generating and information calculating processes.

In the subroutine SUB4, the quality estimator 74 calculates, as shown in FIG. 7, the quality of service on the basis of the network candidate information 76 and the read out operational expressions 64 in the above manner, and outputs the calculated quality as the service quality estimation information 76 on the quality to the candidate information generator 72. Following the subroutine SUB4, the control returns to the substep SS76 for determining whether to acquire the service quality estimation information 76.

In the threshold value determining substep SS78 in the candidate information generator 72, it is determined whether or not the service quality estimation information 76 included in the generated pieces of control candidate information and representing the quality of service supplied from the quality estimator 74 is equal to or higher than the predetermined control modification reference value. When this condition is true, or satisfied (YES), it is represented that the service quality estimation information 76 contains the specific candidate information which would render a value representing the quality equal to or higher than the predetermined control modification reference value. The specific candidate information is information including control contents providing a value and the quality of service equal to or higher than the predetermined control modification reference value. In this case, the control progresses to a selection output substep SS80. Otherwise, namely, when this condition is false, or unsatisfied (NO), the control progresses to a candidate generating substep SS82.

In the selection output process SS80, when the candidate information generator 72 acquires the pieces of specific candidate information, it outputs a piece of specific candidate information providing the highest quality of service to the network controller 38. When the candidate information generator 72 acquires one piece of specific candidate information, it outputs this piece of specific candidate information without modification to the network controller 38. Subsequent to the output substep, the control returns to finish the subroutine SUB7.

In the candidate generating process SS82, the candidate information generator 72 generates a new piece of control candidate information different from the existent pieces of control candidate information, and calculates loads on the basis of the generated piece of control candidate information. The candidate information generator 72 uses the respective pieces of control candidate information as genetic codes and crosses those genetic codes over each other to thereby generate new pieces of control candidate information. After that process, the control returns to the output substep SS74 for the network candidate information through a connector B to repeat the searching process.

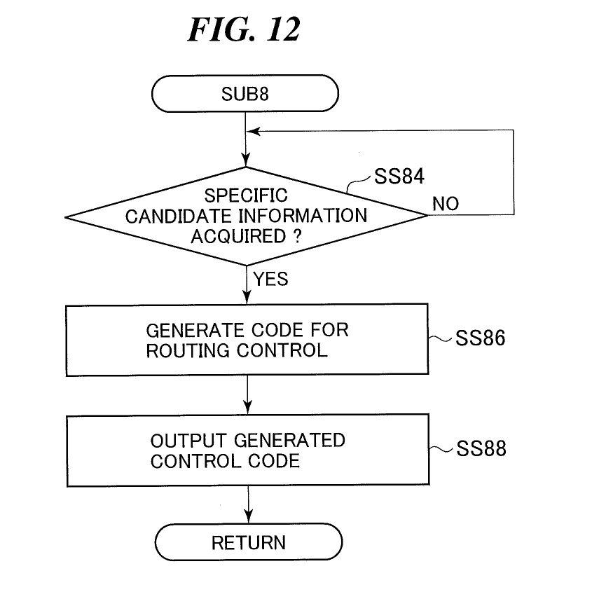

Next, a network control process SUB8 by the network controller 38 will be described with reference to FIG. 12. The network controller 38 determines whether to acquire the specific candidate information 78 (substep SS84). When the network controller 38 determines to acquire the specific candidate information 78 (YES), it progresses to a control substep SS86. Otherwise, namely, when the network controller 38 determines not to acquire the specific candidate information 78 (NO), it keeps waiting on the loop of substep SS84.

In the control substep SS86, the network controller 38 generates from the supplied specific candidate information, for example, a code for routing control based on control contents for the routers 14a, 14b, 14c and so on. Then, the generated code for routing control is outputted to the routers 14a, 14b, 14c and so on (substep SS88). After the output substep, the control returns to finish the subroutine SUB8.

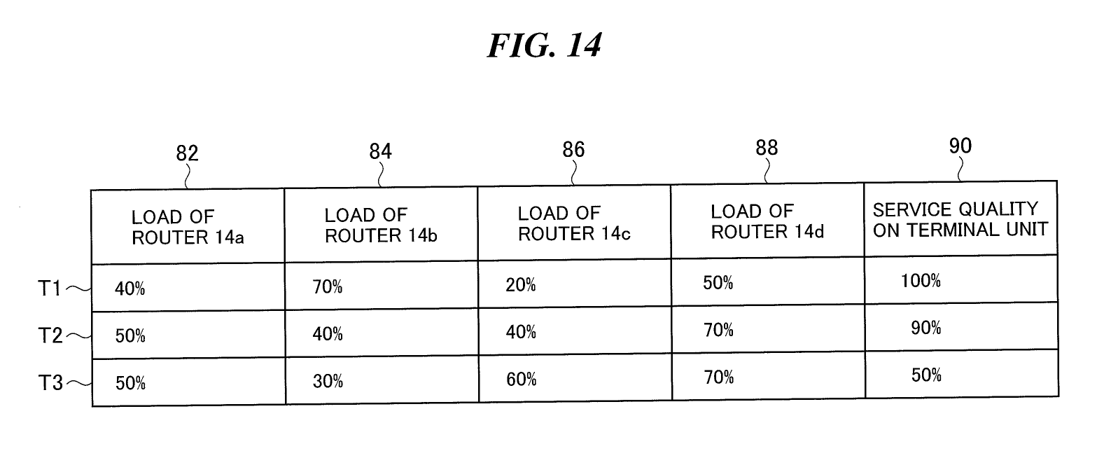

Now, description will be made on the operation of the service quality monitoring system 10 to which the network monitoring system in accordance with the present invention is applied, with reference to FIGS. 13 and 14. A more specific example of operation is directed to the telecommunications network 12 including the four routers 14a, 14b, 14c and 14d interconnected to one another with links L4 to L7, as shown in FIG. 13. The routers 14a, 14b and 14c are connected with other links L1, L2 and L3, respectively, to the exterior. The remaining router 14d is connected to the terminal unit 18. The gateway unit 16 is omitted from this preferred embodiment. The service quality monitoring system 10 is thus configured to calculate the quality of service on the terminal unit 18.

The loads 82 to 88 on the routers 14a to 14d, respectively, and service quality 90 on the terminal unit 18 are shown in FIG. 14. At time T1, as shown in the second top line of FIG. 14, the loads 82 to 88 of the routers 14a to 14d were equal to 40% (=0.4), 70% (=0.7), 20% (=0.2) and 50% (=0.5), respectively, and the service quality 90 of the terminal unit 18 was equal to 100% (=1). The communication quality monitoring apparatus 20 collects and learns those resultant data. Therefore, after having finished this learning, the communication quality monitoring apparatus 20 substitutes, or places, the loads 82 to 88 into the respective parameters of the input layer of the neural network to estimate the service quality 90 of the terminal unit 18. In this case, the estimated service quality 90 is almost equal to 100%.

Thereafter, at time T2, as shown in the third line in the figure, the loads 82 to 88 of the routers 14a to 14d were equal to 50% (=0.5), 40% (=0.4), 40% (=0.4) and 70% (=0.7), respectively, and the service quality 90 of the terminal unit 18 was equal to 90% (=0.9). The communication quality monitoring apparatus 20 collects and learns those resultant data. Thereafter also, the communication quality monitoring apparatus 20 repeats the learning at a timing of sampling and improves the accuracy of the operational expressions.

At time T3, as shown in the bottom line of the figure, the loads 82 to 88 of the routers 14a to 14d were equal to 50% (=0.5), 30% (=0.3), 60% (=0.6) and 70% (=0.7), respectively, and the service quality 90 of the terminal unit 18 was equal to 50% (=0.5). The communication quality monitoring apparatus 20 collects and learns those resultant data, but at this time, the value of the service quality was determined to be lower than the predetermined control modification reference value. The communication quality monitoring apparatus 20 in response modifies control contents for the routers 14a to 14d.

Specifically, the communication quality monitoring apparatus 20 generates, in order to reduce the largest load having a value of 70% at time T3 of the router 14d, a first piece of control candidate information representing control contents that allow the router 14b to direct packets entering on the link L2 to the network 12 to leave the network 12 over the link L3 to the router 14a and the router 14c to direct packets entering the network 12 on the link L3 to leave the network 12 over the link L2 also to the router 14a. The communication quality monitoring apparatus 20 further generates a second piece of control candidate information allowing the router 14a to direct packets entering the network 12 over the link L1 to travel to the terminal unit 18 to the router 14b.

The communication quality monitoring apparatus 20 calculates the loads of the routers 14a to 14d and the service quality on the terminal unit 18 for each of those pieces of control candidate information. As a result, the loads of the routers 14a to 14d corresponding to the first piece of control candidate information were estimated as 70%, 30%, 60% and 50%, respectively, and the service quality was calculated as 60%.

Well, according to the correspondence relationship at time T1 and T2, even when the load of the router 14d is changed, the service quality on the terminal unit 18 is hardly changed. Furthermore, according to the correspondence relationship at time T2 and T3, the load of the router 14c is increased from 40% to 60% while the service quality deteriorates from 90% to 50% accordingly. Thus, it can be assumed that the above results may likely be brought about.

In estimation corresponding to the second piece of control candidate information, the loads of the routers 14a to 14d are estimated as 50%, 60%, 30% and 50%, respectively, and the service quality of the terminal unit 18 is estimated as 95%. It is expected that, among those loads, the loads of the routers 14a, 14b and 14d are approximated to the loads at time T1, and the load of the router 14c is significantly decreased from the load at time T3.

Therefore, the communication quality monitoring apparatus 20 selects the second piece of control candidate information providing the service quality equal to or higher than the predetermined control modification reference value as specific candidate information, and the routers 14a to 14d will be controlled on the basis of this specific candidate information.

In summary, the service quality monitoring system 10 in accordance with the instant illustrative embodiment learns the correspondence relationship between the loads of the routers 14a, 14b, 14c and so on and the quality of service, and when the quality of service is lower than the predetermined control modification reference value the system selects control contents for the routers 14a, 14b, 14c and so on so as to render the quality of the service to be equal to or higher than the predetermined control modification reference value on the basis of the learned correspondence relationship.

Thus, the service quality monitoring system 10 selects control contents for the routers 14a, 14b, 14c and so on so as to cause the quality of service to be equal to or higher than the predetermined control modification reference value, regardless of the loads of the routers 14a, 14b, 14c and so on. That can improve the quality of service even when the degree of failure, or malfunction, in the routers 14a, 14b, 14c and so on does not directly relate to the quality of service.

Furthermore, the service quality monitoring system 10 updates the operational expressions in the order through learning, which may cause the quality of service for various loads of the routers 14a, 14b, 14c and so on to be accurately estimated. For example, even when a piece of control candidate information generated by the candidate information generator 72 represents routing control not performed until now, the service quality monitoring system 10 uses operational expressions to thereby accurately estimate the quality of service associated with this piece of control candidate information. Particularly, if the terminal unit 18 is implemented as a mobile unit, routing control may change oftener. Even in such environment, the service quality monitoring system 10 accurately performs learning.

More specifically, the service quality monitoring system 10 learns the parameters of the neural network through back propagation, which can accomplish accurate learning even on a nonlinear correspondence relationship such as the correspondence relationship between the loads of the routers 14a, 14b, 14c and so on and the quality of service of the terminal unit 18.

Additionally, the service quality monitoring system 10 generates pieces of the control candidate information, estimates the quality of service corresponding to each piece of the control candidate information by means of the neural network, and selects as specific candidate information a piece of control candidate information leading to the estimated quality of service equal to or higher than the predetermined control modification reference value. The service quality monitoring system 10 thus does not rely upon trial and error actually performing control contents represented by control candidate information on the network 12 in order to estimate the quality of service but virtually estimating the quality of service by means of the neural network. The inventive solution can estimate the quality of service without affecting the network 12.

Further with the service quality monitoring system 10, when no piece of control candidate information exists which renders the quality of service equal to or higher than the predetermined control modification reference value, pieces of the control candidate information are dealt with as genetic codes, which will be crossed over each other to thereby generate new pieces of control candidate information. That may cause the service quality monitoring system 10 to efficiently generate control candidate information. For example, the service quality monitoring system 10 may select such one or ones of the pieces of control candidate information that renders or render the quality of service equal to or higher than the cull reference value, and cross the selected pieces over each other. It is therefore expected that newly generated pieces of control candidate information may render the quality of service closer to the predetermined control modification reference value.

Furthermore, even when the network 12 changes in configuration, the configuration after changed may be stored in the configuration information memory 34, from which control candidate information will be produced. The service quality monitoring system 10 can therefore follow a change in configuration of the network.

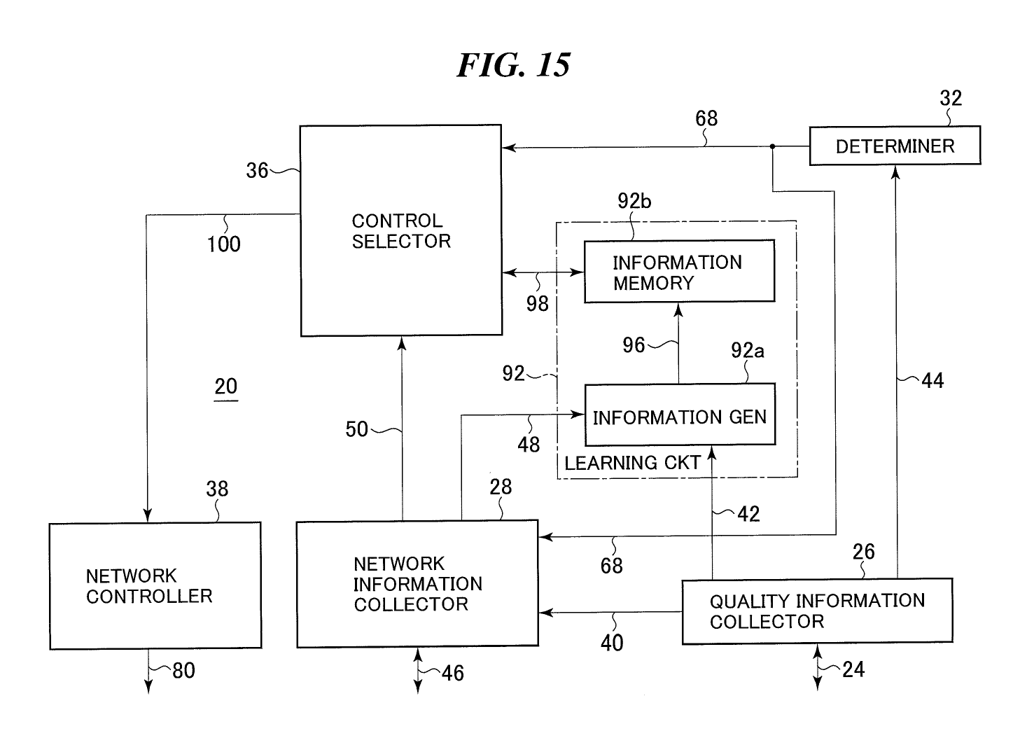

Now, an alternative embodiment of the service quality monitoring system 10 will be described. The alternative embodiment may be the same as the preceding embodiment except, as seen from FIG. 15, for some components or elements included in the communication quality monitoring apparatus 20. In the alternative embodiment, the service quality monitoring system 10 may be the same in connection of the routers 14a, 14b, 14c and so on and the gateway unit 16 in the network 12, the terminal unit 18, and the communication quality monitoring apparatus 20 as the preceding embodiment shown in and described with reference to FIG. 2. Of course, like components and elements are designated with the same reference numerals, and repetitive descriptions thereon will be avoided.

The communication quality monitoring apparatus 20 in the alternative embodiment includes a learning circuit 92, in addition to the quality information collector 26, the network information collector 28, the determiner 32, the control selector 36 and the network controller 38. In the communication quality monitoring apparatus 20, the quality information collector 26, the control selector 36 and the network controller 38 may basically have the same function as the preceding embodiment.

In the alternative embodiment, the network information collector 28 may have the same function as the preceding embodiment, as well as the function of being operative in response to a determination signal containing the anomaly information 68 being received from the determiner 32 to collect the network information 46 at a predetermined timing at which the service quality information 40 is supplied to output the network information 48 and 50. That may allow the network information collector 28 to be operated only in an abnormal state.

The learning circuit 92 includes an information generator 92a and an information memory 92b in order to implement the function attained in the preceding embodiment. The information generator 92a has a function to associate the service quality information 42 supplied from the quality information collector 26 with the network information 48 supplied from the network information collector 28, and supplies the information memory 92b with correspondence information 96 representative of both pieces of information 42 and 48 related in correspondence obtained from that function. The information memory 92b stores the correspondence information 96. Thus, the information generator 92a would not implement integrally the functions of the quality estimator 56 and the quality learning circuit 58 in the preceding embodiment shown in FIG. 2, i.e. the functions of estimating the loads of the routers 14a, 14b, 14c and so on and the quality of service and learning the correspondence relationship therebetween to output resultant operational expressions. The information generator 92a is thus not adapted to perform a complicated calculation process, so that the calculation process can significantly reduce the load on the information generator 92a. The information memory 92b is almost equivalent to the quality memory 54 in the preceding embodiment. Specifically, the information memory 92b is adapted to store pieces of network information in association with pieces of service quality information, and is operative in response to the control selector 36 retrieving to develop network information 98, described later on, to the control selector 36.

The determiner 32 is adapted for determining whether or not the quality of service found on the basis of the supplied service quality information 44 is lower than a predetermined control modification reference value. When the determiner 32 determines that this condition is satisfied, or true, it outputs the anomaly information 68 representing the occurrence of an anomaly in the quality of service to the network information collector 28 and the control selector 36. The predetermined control modification reference value may be set to an arbitrary value, e.g. 0.7 (70%) in the present alternative embodiment.

The control selector 36 is adapted to be responsive to the anomaly information 68 being received to search the information memory 92b of the learning circuit 92 for network information causing the value of the quality of service to be equal to or higher than the predetermined control modification reference value to develop the retrieved network information 98. The control selector 36 is adapted to effect the retrieval only by means of the correspondence relationship stored in the information memory 92b. The retrieving may thus remove complicated calculation. The control selector 36 is further adapted to select such one of the pieces of network information obtained by the retrieving that corresponds to the load closest to a current load to output the selected piece of information. The control selector 36 outputs the read out network information 98 as network information 100 to the network controller 38.

More specifically, among pieces of network information bringing about the service quality equal to or higher than the predetermined control modification reference value, the control selector 36 retrieves a piece of network information associated with the load closest to a current load represented by the network information 48 supplied from the network information collector 28. In other words, the control selector 36 calculates differences, as errors, of the loads for each of the routers 14a, 14b, 14c and so on, and retrieves a piece of network information corresponding to the sum of the absolute values of the differences being minimum from the information memory 92b.

The network controller 38 is adapted for generate control codes such as to cause the loads of the routers 14a, 14b, 14c and so on to match the network information 100 supplied from the control selector 36, and use the generated control codes 80 to control the routers 14a, 14b, 14c and so on.

Next, the operation of the service quality monitoring system 10 in accordance with the alternative embodiment will be briefly described. In the preceding embodiment shown in and described with reference to FIG. 2, the network information 48 supplied by the learning estimator 30 is used to estimate the loads of the routers 14a, 14b, 14c and so on and the quality of service to perform the learning. The instant alternative embodiment is specifically characterized in storing the service quality information 42 in association with the network information 48. The associative storage may render the learning circuit 92 significantly reduced in processing load in comparison with the learning estimator 30, FIG. 2.

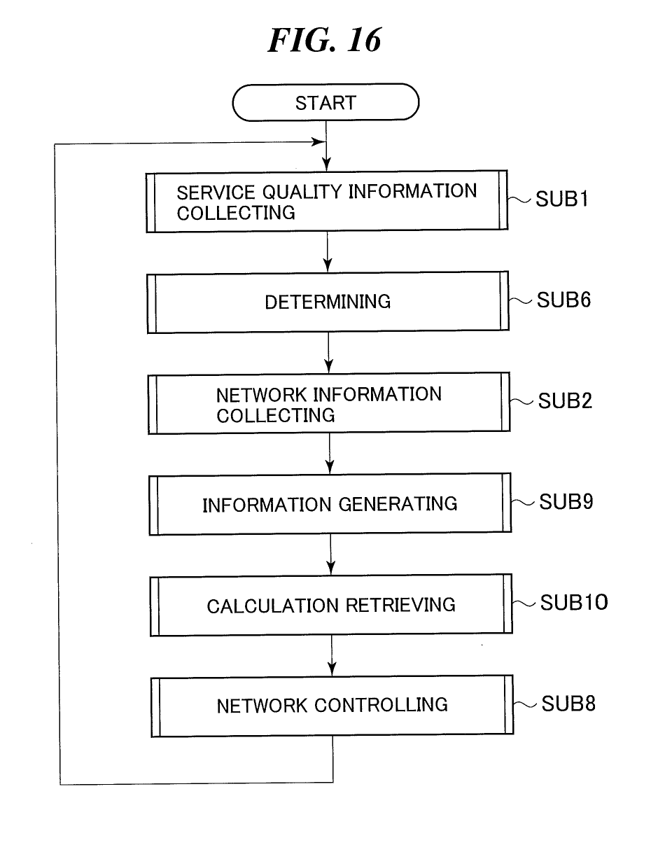

The service quality monitoring system 10 of the alternative embodiment operates to repeat, as shown in FIG. 16, the service quality information collecting process, or subroutine, SUB1, the determining process SUB6, the network information collecting process SUB2, an information generating process SUB9, a calculation retrieving process SUB10, and the network controlling process SUB8.

The instant alternative embodiment is somewhat different from the preceding embodiment in components and elements, as described above, and hence in output destinations. However, the same in procedure are the service quality information collecting process SUB1, the determining process SUB6, the network information collecting process SUB2, and the network controlling process SUB8. Since the output destinations are clearly read from the connection relationship described above, they will not described in order to avoid redundancy.

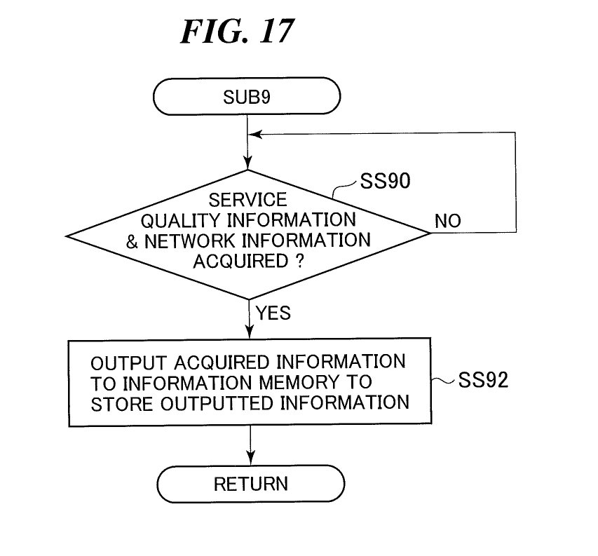

Now, the information generating process SUB9 by the information generator 92a in the alternative embodiment is shown in FIG. 17. In the information generating substep SS90 in the information generator 92a, it is determined whether or not both the service quality information 42 and the network information 48 are supplied. When the information generator 92a determines to acquire both the service quality information 42 and the network information 48 (YES), it progresses to a correspondence output substep SS92. Otherwise, namely, when the information generator 92a determines not to acquire both the service quality information 42 and the network information 48 (NO), it keeps waiting process until receiving both the service quality information 42 and the network information 48 in the loop to the substep SS90.

In the correspondence output substep SS92, the information generator 92a associates the service quality information 42 with the network information 48, and outputs both the information to the information memory 92b to store the information therein. After the correspondence output process, the control returns to finish the information generating subroutine SUB9.

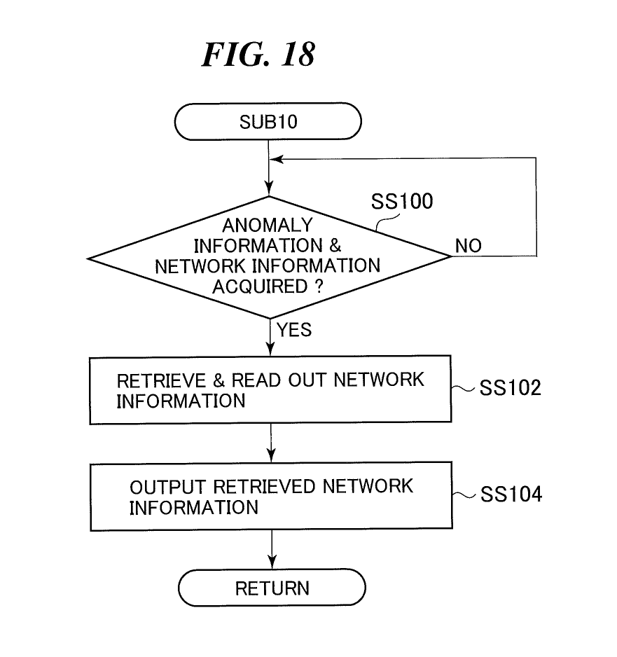

The calculation retrieving process SUB10 by the control selector 36 in the alternative embodiment is shown in FIG. 18. In the calculation retrieving process SUB10, it is determined whether or not both the anomaly information 68 and the network information 50 are supplied (substep SS100). When the control selector 36 determines to acquire both the anomaly information 68 and the network information 50 (YES), it progresses to a retrieving process (to a substep SS102. Otherwise, namely, when the control selector 36 determines not to acquire both the anomaly information 68 and the network information 50 (NO), it keeps waiting until receiving both the anomaly information 68 and the network information 50 to return along the loop to the substep SS100.

In the retrieving process SS102 of the control selector 36, the network information rendering the service quality to be equal to or higher than the predetermined control modification reference value is retrieved from the information memory 92b in the earlier-described manner. In the retrieving process, errors, or differences, of the loads are calculated out for each of the routers to retrieve a piece of network information having the sum of absolute values of the errors being minimum. Therefore, this retrieving also involves a selection function.

Subsequently, in an output substep SS104, the control selector 36 outputs the retrieved network information 98 to the network controller 38. Following the output process, the control returns to finish the calculation retrieving subroutine SUB10. The network controller 38 generates a control code based the supplied network information 100 to control the routers 14a, 14b, 14c and so on (subroutine SUB8).

In summary, in accordance with the alternative embodiment, the service quality monitoring system 10 learns the correspondence relationship between loads of the routers 14a, 14b, 14c and so on and the quality of service of the terminal unit 18. When the quality of the service is lower than the predetermined control modification reference value, the monitoring system 10 uses the learned correspondence relationship to retrieve and select control contents for the routers 14a, 14b, 14c and so on such as to render the quality of the service equal to or higher than the predetermined control modification reference value. Therefore, the service quality monitoring system 10 can select control contents for the routers 14a, 14b, 14c and so on such that the quality of service will be equal to or higher than the predetermined control modification reference value regardless of the loads of the routers 14a, 14b, 14c and so on. That can improve the quality of the service even when the degree of failure in the routers 14a, 14b, 14c and so on does not directly relate to the quality of service.

Additionally, the service quality monitoring system 10 can improve the quality of service by means of simpler configuration than the preceding embodiment.

While the present invention has been described with reference to the particular illustrative embodiments, it is not to be restricted by the embodiments. It is to be appreciated that those skilled in the art can change or modify the embodiments without departing from the scope and spirit of the present invention.

The two illustrative embodiments described above are based upon a learning method using a neural network. However, the present invention is not restricted by this specific method. Other alternative methods may be employed, and plural methods may be employed in combination. The communication quality monitoring apparatus 20 may be adapted to learn by both neural network and Bayes methods, and estimate service quality for control candidate information generated by the candidate information generator 72 on the basis of the results of both learning methods so as to use the generated control candidate information as specific candidate information when both of the estimated service quality data are equal to or higher than the predetermined control modification reference value.

In short, the present invention may also be summarized by the following aspects:

1. A network monitoring system including a plurality of network devices constituting a telecommunications network, a terminal unit connected to the network and receiving a service provided over the network, and a network monitoring apparatus for monitoring the network devices,

said network monitoring apparatus comprising:

a network information collector collecting network information on a load of each of the plurality of network devices;

a service quality information collector collecting service quality information on a quality of a service provided over the network;

a learning estimator using the collected network information and an operational expression for deriving the quality of the service to update the operational expression on a basis of a difference between estimation information on estimation of the quality of the service and the service quality information to learn a correspondence relationship between the load of each of the network devices and the quality of the service;

a determiner using the collected service quality information to determine whether or not the quality of the service is lower than a predetermined control modification reference value;

a control selector operative in response to said determiner determining that the quality of the service is lower than the predetermined control modification reference value to generate a piece of candidate information of control contents based on the network information and configuration information of the network, and determining, before control, whether or not service quality estimation information for search obtained on the basis of the piece of candidate information and the operational expression has a first value equal to or higher than the predetermined control modification reference value, said control selector selecting such one of the pieces of candidate information for the network devices that is determined to have the first value; and

a network controller operative in response to the control contents included in the selected piece of candidate information to control the network devices.

2. A network monitoring system including a plurality of network devices constituting a telecommunications network, a terminal unit connected to the network and receiving a service provided over the network, and a network monitoring apparatus for monitoring the network devices,

said network monitoring apparatus comprising:

a network information collector collecting network information on a load of each of the plurality of network devices;

a service quality information collector collecting service quality information on a quality of service provided over the network;

a learning circuit storing the collected network information in association with the collected service quality information, and learning a correspondence relationship between the loads of the network devices and the quality of the service;

a determiner using the collected service quality information to determine whether or not the quality of the service is lower than a predetermined control modification reference value;

a control selector operative in response to said determiner determining that the quality of the service is lower than the predetermined control modification reference value to search said learning circuit for the network information stored in said learning circuit to determine, before control, whether or not of the quality of the service read out on a basis of the network information has a value equal to or higher than the predetermined control modification reference value; and

a network controller controlling the network devices on the basis of the selected network information,

said control selector further selecting such one of pieces of network information obtained through the retrieval that is closest to a current load to output the selected piece of network information.

The entire disclosure of Japanese patent application No. 2010-245257 filed on Nov. 1, 2010, including the specification, claims, accompanying drawings and abstract of the disclosure, is incorporated herein by reference in its entirety.

What is claimed is:

1. A network monitoring apparatus comprising:
a network information collector collecting network information on a load of each of a plurality of network devices constituting a telecommunications network;
a service quality information collector collecting service quality information on a quality of a service provided over the network;
a learning estimator using the collected network information and an operational expression for deriving the quality of the service to update the operational expression on a basis of a difference between estimation information on estimation of the quality of the service and the service quality information to learn a correspondence relationship between the load of each of the network devices and the quality of the service;
a determiner using the collected service quality information to determine whether or not the quality of the service is lower than a predetermined control modification reference value;
a control selector operative in response to said determiner determining that the quality of the service is lower than the predetermined control modification reference value to generate a piece of candidate information of control contents based on the network information and configuration information of the network, and determining, before control, whether or not service quality estimation information for search obtained on the basis of the piece of candidate information and the operational expression has a first value equal to or higher than the predetermined control modification reference value, said control selector selecting such one of the pieces of candidate information for the network devices that is determined to lead to the first value; and
a network controller operative in response to the control contents included in the selected piece of candidate information to control the network devices.

2. The apparatus in accordance with claim 1, wherein said learning estimator includes:
a quality estimator estimating the quality of the service on the basis of an operational expression for deriving the quality of the service from the load of each of the network devices and the collected network information; and
a quality learning circuit updating the operational expression on the basis of a difference between the estimated quality of the service and the quality of the service represented by the service quality information to learn the correspondence relationship.

3. The apparatus in accordance with claim 1, wherein
the load of each of the network devices corresponds to an input layer of a neural network,
the quality of the service corresponds to an output layer of the neural network,
the operational expression is an operational expression for deriving a value of each of layers constituting the neural network, and
said learning estimator substitutes the load represented by the network information into the input layer, and uses the operational expression to calculate the quality of the service, said learning estimator updating the operational expression through back propagation on the basis of a difference between the calculated quality of the service and the quality of the service represented by the collected service quality information.

4. The apparatus in accordance with claim 1, wherein said control selector includes:
a candidate information generator generating pieces of candidate information representing control contents for the network devices, and calculating the loads of the network devices to be caused when controlled by the control contents represented by each of the generated pieces of candidate information; and
a quality estimator for search for calculating the quality of the service for search on the basis of the calculated loads of the network devices and the operational expression,
said candidate information generator repetitively determining whether or not the calculated quality of the service is equal to or higher than the predetermined control modification reference value until obtaining the piece of candidate information,
said candidate information generator setting as specific candidate information the piece of candidate information rendering the quality of the service to be equal to or higher than the predetermined control modification reference value, and selecting the specific candidate information as the control contents for the network devices.

5. The apparatus in accordance with claim 4, wherein when the specific candidate information is not obtained, said candidate information generator deals with the pieces of candidate information as genetic codes, and crosses the genetic codes over one another to generate a new piece of candidate information.

6. A network monitoring apparatus comprising:
a network information collector collecting network information on a load of each of a plurality of network devices constituting a telecommunications network;
a service quality information collector collecting service quality information on a quality of service provided over the network;
a learning circuit storing the collected network information in association with the collected service quality information, and learning a correspondence relationship between the loads of the network devices and the quality of the service;
a determiner using the collected service quality information to determine whether or not the quality of the service is lower than a predetermined control modification reference value;
a control selector operative in response to said determiner determining that the quality of the service is lower than the predetermined control modification reference value to search said learning circuit for the network information stored in said learning circuit to determine, before control, whether or not a value of the quality of the service read out on a basis of the network information is equal to or higher than the predetermined control modification reference value; and
a network controller controlling the network devices on the basis of the selected network information,
said control selector further selecting such one of pieces of network information obtained through the retrieval that is closest to a current load to output the selected piece of network information.

7. The apparatus in accordance with claim 6, wherein said learning circuit includes:
an information generator associating the collected service quality information with the collected network information; and
an information memory for storing as correspondence information the service quality information and the network information when being in the obtained correspondence relationship.

8. A method for monitoring a telecommunications network constituted by a plurality of network devices in a system including a terminal unit connected to the network and receiving a service provided over the network and a network monitoring apparatus for monitoring the network devices, said method comprising:
in the network monitoring apparatus,
a first step of collecting network information on a load of each of the network devices;
a second step of collecting service quality information on a quality of a service provided over the network;
a third step of using the collected network information and the collected service quality information to learn a correspondence relationship between the load of each of the network devices and the quality of the service;
a fourth step of determining whether or not the quality of the service is lower than a predetermined control modification reference value on a basis of the collected service quality information;
a fifth step of estimating, when it is determined that the quality of the service is lower than the predetermined control modification reference value, the quality of the service on the basis of the learned correspondence relationship, and selecting information on a correspondence relationship in which the estimated quality of the service takes a value equal to or higher than the predetermined control modification reference value as control contents for the network devices; and
a sixth step of controlling the network devices on the basis of the selected control contents.

9. The method in accordance with claim 8, wherein said third step uses the collected network information and an operational expression for deriving the quality of the service to update the operational expression on the basis of a difference between estimation information on estimation of the quality of the service and the service quality information to learn the correspondence relationship between the load of each of the network devices and the quality of the service.

10. The method in accordance with claim 9, wherein said third step includes:
estimating the quality of the service on the basis of the operational expression for deriving the quality of the service from the loads of the network devices and the collected network information; and
updating the operational expression on the basis of a difference between the estimated quality of the service and the quality of the service represented by the service quality information to learn the correspondence relationship.

11. The method in accordance with claim 8, wherein
the load of each of the network devices corresponds to an input layer of a neural network,
the quality of the service corresponds to an output layer of the neural network,
the operational expression is an operational expression for deriving a value of each of layers constituting the neural network, and
said third step substitutes the load represented by the network information into the input layer, uses the operational expression to calculate the quality of the service, and updates the operational expression through back propagation on the basis of a difference between the calculated quality of the service and the quality of the service represented by the collected service quality information.

12. The method in accordance with claim 9, wherein said fifth step includes:
generating pieces of candidate information representing control contents for the network devices, and calculating the loads of the network devices to be caused when controlled by the control contents represented by each of the generated pieces of candidate information; and
calculating for search the quality of the service for search on the basis of the calculated loads of the network devices and the operational expression,
said fifth step being performed by repetitively determining whether or not the calculated quality of the service is equal to or higher than the predetermined control modification reference value until obtaining the piece of candidate information,
said fifth step setting as specific candidate information the piece of candidate information rendering the quality of the service to be equal to or higher than the predetermined control modification reference value, and selecting the specific candidate information as the control contents for the network devices.

13. The method in accordance with claim 12, wherein, when the specific candidate information is not obtained, said fifth step deals with the pieces of candidate information as genetic codes, and crosses the genetic codes over one another to generate a new piece of candidate information.

14. The method in accordance with claim 8, wherein said third step stores the collected network information in association with the collected service quality information to learn the correspondence relationship between the load of each of the network devices and the quality of the service.

15. The method in accordance with claim 14, wherein when it is determined that the quality of the service is lower than the predetermined control modification reference value, said fifth step searches for the network information to determine, before control, whether or not a value of the quality of the service read out on a basis of the network information is equal to or higher than the predetermined control modification reference value,
said fifth step selecting such one of pieces of network information obtained through the retrieval that is closest to a current load to output the selected piece of network information.

16. The method in accordance with claim 8, wherein said third step includes:
associating the collected service quality information with the collected network information; and
storing as correspondence information the service quality information and the network information when being in the obtained correspondence relationship.

17. A computer-readable record medium storing a monitoring program causing a computer to serve:
a first information collecting function of collecting network information on a load of each of a plurality of network devices constituting a telecommunications network;
a second information collecting function of collecting service quality information on a quality of a service provided over the network;
a learning function of using the collected network information and the collected service quality information to learn a correspondence relationship between the load of each of the network devices and the quality of the service;
a determining function of determining whether or not the quality of the service is lower than a predetermined control modification reference value on a basis of the collected service quality information;
a control selecting function of estimating, when it is determined that the quality of the service is lower than the predetermined control modification reference value, the quality of the service on the basis of the learned correspondence relationship, and selecting information on a correspondence relationship in which the estimated quality of the service takes a value equal to or higher than the predetermined control modification reference value as control contents for the network devices; and
a control function of controlling the network devices on the basis of the selected control contents.
